(19) United States
(12) Patent Application Publication
(10) Pub. No.: US 2023/0194716 A1
(43) Pub. Date: Jun. 22, 2023

(54) OBJECT TRACKING

(71) Applicant: FARO Technologies, Inc., Lake Mary, FL (US)

(72) Inventors: Udo HAEDICKE, Leipzig (DE); Denis WOHLFELD, Ludwigsburg (DE); Oliver ZWEIGLE, Stuttgart (DE)

(21) Appl. No.: 18/077,791

(22) Filed: Dec. 8, 2022

Related U.S. Application Data
(60) Provisional application No. 63/397,990, filed on Aug. 15, 2022.
(60) Provisional application No. 63/290,223, filed on Dec. 16, 2021.

(51) Int. Cl. G01S 17/66; G06T 7/521; G06T 7/246; G01S 17/89; G01S 7/51; G01S 7/48

(52) U.S. Cl. CPC G01S 17/66; G06T 7/521; G06T 7/246; G01S 17/89; G01S 7/51; G01S 7/4808; G06T 2207/10028

(57) ABSTRACT

Examples described herein provide a method that includes receiving point cloud data from a three-dimensional (3D) coordinate measurement device, the point cloud data corresponding at least in part to the object. The method further includes analyzing, by a processing system, the point cloud data by comparing a point of the point cloud data to a corresponding reference point from reference data to determine a distance between the point and the corresponding reference point, wherein the point and the corresponding reference point are associated with the object. The method further includes determining, by the processing system, whether a change to a location of the object occurred by comparing the distance to a distance threshold. The method further includes, responsive to determining that the change to the location of the object occurred, displaying a change indicium on a display of the processing system.

### CROSS-REFERENCE TO RELATED APPLICATIONS

This application claims the benefit of U.S. Provisional Patent Application No. 63/397,990 filed Aug. 15, 2022, and U.S. Provisional Patent Application No. 63/290,223 filed Dec. 16, 2021, the disclosure of which is incorporated herein by reference in its entirety.

### BACKGROUND

The subject matter disclosed herein relates to use of a 3D laser scanner time-of-flight (TOF) coordinate measurement device. A 3D laser scanner of this type steers a beam of light to a non-cooperative target such as a diffusely scattering surface of an object. A distance meter in the device measures a distance to the object, and angular encoders measure the angles of rotation of two axles in the device. The measured distance and two angles enable a processor in the device to determine the 3D coordinates of the target.

A TOF laser scanner is a scanner in which the distance to a target point is determined based on the speed of light in air between the scanner and a target point. Laser scanners are typically used for scanning closed or open spaces such as interior areas of buildings, industrial installations and tunnels. They may be used, for example, in industrial applications and accident reconstruction applications. A laser scanner optically scans and measures objects in a volume around the scanner through the acquisition of data points representing object surfaces within the volume. Such data points are obtained by transmitting a beam of light onto the objects and collecting the reflected or scattered light to determine the distance, two-angles (i.e., an azimuth and a zenith angle), and optionally a gray-scale value. This raw scan data is collected, stored and sent to a processor or processors to generate a 3D image representing the scanned area or object.

Generating an image requires at least three values for each data point. These three values may include the distance and two angles, or may be transformed values, such as the x, y, z coordinates. In an embodiment, an image is also based on a fourth gray-scale value, which is a value related to irradiance of scattered light returning to the scanner.

Most TOF scanners direct the beam of light within the measurement volume by steering the light with a beam steering mechanism. The beam steering mechanism includes a first motor that steers the beam of light about a first axis by a first angle that is measured by a first angular encoder (or other angle transducer). The beam steering mechanism also includes a second motor that steers the beam of light about a second axis by a second angle that is measured by a second angular encoder (or other angle transducer).

Many contemporary laser scanners include a camera mounted on the laser scanner for gathering camera digital images of the environment and for presenting the camera digital images to an operator of the laser scanner. By viewing the camera images, the operator of the scanner can determine the field of view of the measured volume and adjust settings on the laser scanner to measure over a larger or smaller region of space. In addition, the camera digital images may be transmitted to a processor to add color to the scanner image. To generate a color scanner image, at least three positional coordinates (such as x, y, z) and three color values (such as red, green, blue “RGB”) are collected for each data point.

One application where 3D scanners are used is to determine a flatness of a newly poured concrete floor in construction. Where the new construction is a warehouse, the floor flatness may be tightly specified so that vehicles, such as forklifts for example, do not tip while in use.

Accordingly, while existing 3D scanners are suitable for their intended purposes, what is needed is a 3D scanner having certain features of embodiments of the present invention.

### BRIEF DESCRIPTION

According to an embodiment, a method is provided. The method includes performing at least one scan with a laser scanner, the laser scanner to generate a data set that includes a plurality of three-dimensional coordinates of a floor. The method further includes determining, from the plurality of three-dimensional coordinates, with a processing device, a floor flatness and levelness deviation relative to a reference plane. The method further includes displaying, on a computer display, a graphical representation of the floor flatness and levelness deviation. The method further includes adjusting the floor flatness and levelness to be within a predetermined specification in response to determining the floor flatness and levelness deviation.

In addition to one or more of the features described herein, or as an alternative, further embodiments of the method may include: determining an amount of material to add based on the floor flatness and levelness deviation; and dispensing a volume of material based at least in part on the determined amount of material.

In addition to one or more of the features described herein, or as an alternative, further embodiments of the method may include: determining an amount of material to redistribute based on the floor flatness and levelness deviation; and redistributing a volume of material based at least in part on the determined amount of material.

In addition to one or more of the features described herein, or as an alternative, further embodiments of the method may include that the redistributing is performed by a power float.

In addition to one or more of the features described herein, or as an alternative, further embodiments of the method may include: determining an amount of material to remove based on the floor flatness and levelness deviation; and removing a volume of material based at least in part on the determined amount of material.

In addition to one or more of the features described herein, or as an alternative, further embodiments of the method may include that the reference plane is defined based at least in part on a reference point located on or adjacent to the floor.

In addition to one or more of the features described herein, or as an alternative, further embodiments of the method may include: defining the reference plane based at least in part on a reference point located on or adjacent to the floor; defining a number of two-dimensional longitudinal sections extending along a length of the floor; and determining, from the plurality of three-dimensional coordinates, with the processing device, a plurality of floor flatness and levelness deviations relative to the reference plane along each section of the floor.

In addition to one or more of the features described herein, or as an alternative, further embodiments of the method may include that the displaying, on a computer display, includes displaying the plurality of floor flatness and levelness deviations as a function of distance relative to an origin of the section along the section.

In addition to one or more of the features described herein, or as an alternative, further embodiments of the method may include saving the plurality of floor flatness and levelness deviations as a function of distance to a memory.

In addition to one or more of the features described herein, or as an alternative, further embodiments of the method may include that the laser scanner includes: a scanner processing system including a scanner controller; a housing; and a three-dimensional (3D) scanner disposed within the housing and operably coupled to the scanner processing system, the 3D scanner having a light source, a beam steering unit, a first angle measuring device, a second angle measuring device, and a light receiver, the beam steering unit cooperating with the light source and the light receiver to define a scan area, the light source and the light receiver configured to cooperate with the scanner processing system to determine a first distance to a first object point based at least in part on a transmitting of a light by the light source and a receiving of a reflected light by the light receiver, the 3D scanner configured to cooperate with the scanner processing system to determine 3D coordinates of the first object point based at least in part on the first distance, a first angle of rotation, and a second angle of rotation.

In addition to one or more of the features described herein, or as an alternative, further embodiments of the method may include: generating, on a display of a user device, an augmented reality element; and displaying the floor flatness and levelness deviation in the augmented reality element.

In addition to one or more of the features described herein, or as an alternative, further embodiments of the method may include that the floor flatness and levelness deviation is displayed as a function of distance.

In addition to one or more of the features described herein, or as an alternative, further embodiments of the method may include that the floor flatness and levelness deviation is displayed as a heatmap.

According to an embodiment, another method is provided. The method includes performing at least one scan with a laser scanner, the laser scanner to generate a data set that includes a plurality of three-dimensional coordinates of a floor. The method further includes determining, from the plurality of three-dimensional coordinates, with a processing device, a floor flatness and levelness deviation relative to a reference plane. The method further includes comparing the floor flatness and levelness deviation to a threshold deviation. The method further includes, responsive to determining that the floor flatness and levelness deviation fails to satisfy the threshold deviation, correcting a defect of the floor associated with the floor flatness and levelness deviation.

In addition to one or more of the features described herein, or as an alternative, further embodiments of the method may include that correcting the defect includes controlling an automated system to correct the defect of the floor associated with the floor flatness and levelness deviation.

In addition to one or more of the features described herein, or as an alternative, further embodiments of the method may include that the reference plane is defined based at least in part on a reference point located on or adjacent to the floor.

In addition to one or more of the features described herein, or as an alternative, further embodiments of the method may include: defining the reference plane based at least in part on a reference point located on or adjacent to the floor; defining a number of two-dimensional longitudinal sections extending along a length of the floor; and determining, from the plurality of three-dimensional coordinates, with the processing device, a plurality of floor flatness and levelness deviations relative to the reference plane along each section of the floor.

In addition to one or more of the features described herein, or as an alternative, further embodiments of the method may include displaying, on a computer display, the plurality of floor flatness and levelness deviations as a function of distance relative to an origin of the section along the section.

In addition to one or more of the features described herein, or as an alternative, further embodiments of the method may include saving the plurality of floor flatness and levelness deviations as a function of distance to a memory.

In addition to one or more of the features described herein, or as an alternative, further embodiments of the method may include that the laser scanner includes: a scanner processing system including a scanner controller; a housing; and a three-dimensional (3D) scanner disposed within the housing and operably coupled to the scanner processing system, the 3D scanner having a light source, a beam steering unit, a first angle measuring device, a second angle measuring device, and a light receiver, the beam steering unit cooperating with the light source and the light receiver to define a scan area, the light source and the light receiver configured to cooperate with the scanner processing system to determine a first distance to a first object point based at least in part on a transmitting of a light by the light source and a receiving of a reflected light by the light receiver, the 3D scanner configured to cooperate with the scanner processing system to determine 3D coordinates of the first object point based at least in part on the first distance, a first angle of rotation, and a second angle of rotation.

In addition to one or more of the features described herein, or as an alternative, further embodiments of the method may include that correcting the defect associated with the floor flatness and levelness deviation includes: determining an amount of material to add based on the floor flatness and levelness deviation; automatically dispensing a volume of material based at least in part on the determined amount of material; and applying the volume of material to an area associated with the floor flatness and levelness deviation.

In addition to one or more of the features described herein, or as an alternative, further embodiments of the method may include that correcting the defect associated with the floor flatness and levelness deviation includes: determining an amount of material to remove based on the floor flatness and levelness deviation; and removing a volume of material based at least in part on the determined amount of material from an area associated with the floor flatness and levelness deviation.

According to an embodiment, a system is provided. The system includes a laser scanner to perform at least one scan and generate a data set that includes a plurality of three-dimensional coordinates of a floor. The system further includes a processing system. The processing system includes a memory including computer readable instructions and a processing device for executing the computer readable instructions. The computer readable instructions control the processing device to perform operations. The operations include receiving the data set from the laser scanner. The operations further include determining, from the plurality of three-dimensional coordinates, a floor flatness and levelness deviation relative to a reference plane. The operations further include comparing the floor flatness and levelness deviation to a threshold deviation. The operations further include responsive to determining that the floor flatness and levelness deviation fails to satisfy the threshold deviation, performing an action.

In addition to one or more of the features described herein, or as an alternative, further embodiments of the system may include a floor flatness and levelness correcting system, wherein the action includes controlling the floor flatness and levelness correcting system to correct a defect associated with the floor flatness and levelness deviation.

In addition to one or more of the features described herein, or as an alternative, further embodiments of the system may include that the operations further include: defining the reference plane based at least in part on a reference point located on or adjacent to the floor; defining a number of two-dimensional longitudinal sections extending along a length of the floor; and determining from the plurality of three-dimensional coordinates a plurality of floor flatness and levelness deviations relative to the reference plane along each section of the floor.

In addition to one or more of the features described herein, or as an alternative, further embodiments of the system may include that the laser scanner includes: a second processing system including a scanner controller; a housing; and a three-dimensional (3D) scanner disposed within the housing and operably coupled to the second processing system, the 3D scanner having a light source, a beam steering unit, a first angle measuring device, a second angle measuring device, and a light receiver, the beam steering unit cooperating with the light source and the light receiver to define a scan area, the light source and the light receiver configured to cooperate with the second processing system to determine a first distance to a first object point based at least in part on a transmitting of a light by the light source and a receiving of a reflected light by the light receiver, the 3D scanner configured to cooperate with the second processing system to determine 3D coordinates of the first object point based at least in part on the first distance, a first angle of rotation and a second angle of rotation.

According to an embodiment, a method is provided. The method includes performing a scan with a three-dimensional (3D) coordinate measurement device, wherein the 3D coordinate measurement device performs a plurality of rotations about an axis during the scan, wherein the 3D coordinate measurement device captures a plurality of 3D coordinates of an environment during each of the plurality of rotations. The method further includes transmitting, to a processing system, a first plurality of 3D coordinates of the environment captured during a first rotation of the plurality of rotations of the 3D coordinate measurement device, the processing system displaying the first plurality of 3D coordinates, a first at least one flatness indication being presented with the first plurality of 3D coordinates, the first at least one flatness indication being associated with a surface of the environment. The method further includes transmitting, to the processing system, a second plurality of 3D coordinates of the environment captured during a second rotation of the plurality of rotations of the 3D coordinate measurement device, the processing system displaying the second plurality of 3D coordinates instead of the first plurality of 3D coordinates, a second at least one flatness indication being presented with the second plurality of 3D coordinates, the second at least one flatness indication being associated with the surface of the environment. The method further includes adjusting flatness of the surface to be within a predetermined specification based at least in part on at least one of the first at least one flatness indication or the second at least one flatness indication.

In addition to one or more of the features described herein, or as an alternative, further embodiments of the method may include that adjusting the flatness of the surface includes determining an amount of material to add to the surface based at least in part on the at least one of the first at least one flatness indication or the second at least one flatness indication; and dispensing a volume of material based at least in part on the determined amount of material.

In addition to one or more of the features described herein, or as an alternative, further embodiments of the method may include that the at least one of the first at least one flatness indication or the second at least one flatness indication is based at least in part on a reference point located on or adjacent to the surface of the environment.

In addition to one or more of the features described herein, or as an alternative, further embodiments of the method may include that the reference point is used to define a reference plane.

In addition to one or more of the features described herein, or as an alternative, further embodiments of the method may include that the at least one of the first at least one flatness indication or the second at least one flatness indication is based at least in part on the reference plane.

In addition to one or more of the features described herein, or as an alternative, further embodiments of the method may include that the 3D coordinate measurement device is a laser scanner.

In addition to one or more of the features described herein, or as an alternative, further embodiments of the method may include that the laser scanner includes: a scanner processing system including a scanner controller; a housing; and a 3D scanner disposed within the housing and operably coupled to the scanner processing system, the 3D scanner having a light source, a beam steering unit, a first angle measuring device, a second angle measuring device, and a light receiver, the beam steering unit cooperating with the light source and the light receiver to define a scan area, the light source and the light receiver configured to cooperate with the scanner processing system to determine a first distance to a first object point based at least in part on a transmitting of a light by the light source and a receiving of a reflected light by the light receiver, the 3D scanner configured to cooperate with the scanner processing system to determine 3D coordinates of the first object point based at least in part on the first distance, a first angle of rotation, and a second angle of rotation.

In addition to one or more of the features described herein, or as an alternative, further embodiments of the method may include that the at least one of the first at least one flatness indication or the second at least one flatness indication is displayed as an augmented reality element.

In addition to one or more of the features described herein, or as an alternative, further embodiments of the method may include that the at least one of the first at least one flatness indication or the second at least one flatness indication is displayed as a function of distance relative to a reference plane.

In addition to one or more of the features described herein, or as an alternative, further embodiments of the method may include that the at least one of the first at least one flatness indication or the second at least one flatness indication is displayed as a heatmap.

In addition to one or more of the features described herein, or as an alternative, further embodiments of the method may include transmitting the first plurality of 3D coordinates of the environment and the second plurality of 3D coordinates of the environment to a cloud computing environment, wherein a cloud node of the cloud computing environment performs an analysis task responsive to an analysis request and provides analysis results.

According to an embodiment, a three-dimensional (3D) coordinate measurement device is provided. The 3D coordinate measurement device includes a memory having computer readable instructions. The 3D coordinate measurement device further including a processing device for executing the computer readable instructions, the computer readable instructions controlling the processing device to perform operations. The operations include performing a plurality of rotations about an axis during a scan, wherein the 3D coordinate measurement device captures a plurality of 3D coordinates of an environment during each of the plurality of rotations. The operations further include transmitting, to a processing system, a first plurality of 3D coordinates of the environment captured during a first rotation of the plurality of rotations of the 3D coordinate measurement device, the processing system displaying the first plurality of 3D coordinates, a first at least one flatness indication being presented with the first plurality of 3D coordinates, the first at least one flatness indication being associated with a surface of the environment. The operations further include transmitting, to the processing system, a second plurality of 3D coordinates of the environment captured during a second rotation of the plurality of rotations of the 3D coordinate measurement device, the processing system displaying the second plurality of 3D coordinates instead of the first plurality of 3D coordinates, a second at least one flatness indication being presented with the second plurality of 3D coordinates, the second at least one flatness indication being associated with the surface of the environment.

In addition to one or more of the features described herein, or as an alternative, further embodiments of the 3D coordinate measurement device may include that the at least one of the first at least one flatness indication or the second at least one flatness indication is based at least in part on a reference point located on or adjacent to the surface of the environment.

In addition to one or more of the features described herein, or as an alternative, further embodiments of the 3D coordinate measurement device may include that the reference point is used to define a reference plane.

In addition to one or more of the features described herein, or as an alternative, further embodiments of the 3D coordinate measurement device may include that the at least one of the first at least one flatness indication or the second at least one flatness indication is based at least in part on the reference plane.

In addition to one or more of the features described herein, or as an alternative, further embodiments of the 3D coordinate measurement device may include that the 3D coordinate measurement device is a laser scanner.

In addition to one or more of the features described herein, or as an alternative, further embodiments of the 3D coordinate measurement device may include that the laser scanner includes: a scanner processing system including a scanner controller; a housing; and a 3D scanner disposed within the housing and operably coupled to the scanner processing system, the 3D scanner having a light source, a beam steering unit, a first angle measuring device, a second angle measuring device, and a light receiver, the beam steering unit cooperating with the light source and the light receiver to define a scan area, the light source and the light receiver configured to cooperate with the scanner processing system to determine a first distance to a first object point based at least in part on a transmitting of a light by the light source and a receiving of a reflected light by the light receiver, the 3D scanner configured to cooperate with the scanner processing system to determine 3D coordinates of the first object point based at least in part on the first distance, a first angle of rotation, and a second angle of rotation.

In addition to one or more of the features described herein, or as an alternative, further embodiments of the 3D coordinate measurement device may include that the at least one of the first at least one flatness indication or the second at least one flatness indication is displayed as an augmented reality element.

In addition to one or more of the features described herein, or as an alternative, further embodiments of the 3D coordinate measurement device may include that the at least one of the first at least one flatness indication or the second at least one flatness indication is displayed as a function of distance relative to a reference plane.

In addition to one or more of the features described herein, or as an alternative, further embodiments of the 3D coordinate measurement device may include that the at least one of the first at least one flatness indication or the second at least one flatness indication is displayed as a heatmap.

In addition to one or more of the features described herein, or as an alternative, further embodiments of the 3D coordinate measurement device may include that the instructions further include transmitting the first plurality of 3D coordinates of the environment and the second plurality of 3D coordinates of the environment to a cloud computing environment, wherein a cloud node of the cloud computing environment performs an analysis task responsive to an analysis request and provides analysis results.

According to an embodiment, a method for tracking an object is provided. The method includes receiving point cloud data from a three-dimensional (3D) coordinate measurement device, the point cloud data corresponding at least in part to the object. The method further includes analyzing, by a processing system, the point cloud data by comparing a point of the point cloud data to a corresponding reference point from reference data to determine a distance between the point and the corresponding reference point, wherein the point and the corresponding reference point are associated with the object. The method further includes determining, by the processing system, whether a change to a location of the object occurred by comparing the distance to a distance threshold. The method further includes, responsive to determining that the change to the location of the object occurred, displaying a change indicium on a display of the processing system. The point cloud data is captured by performing a scan using the 3D coordinate measurement device. The 3D coordinate measurement device performs a plurality of rotations about an axis during the scan. The 3D coordinate measurement device further captures a plurality of 3D coordinates of the object during each of the plurality of rotations. The 3D coordinate measurement device further transmits, to the processing system, a first plurality of 3D coordinates of the object captured during a first rotation of the plurality of rotations of the 3D coordinate measurement device, the processing system displaying the first plurality of 3D coordinates on the display. The 3D coordinate measurement device further transmits, to the processing system, a second plurality of 3D coordinates of the object captured during a second rotation of the plurality of rotations of the 3D coordinate measurement device, the processing system displaying, on the display, the second plurality of 3D coordinates instead of the first plurality of 3D coordinates.

In addition to one or more of the features described herein, or as an alternative, further embodiments of the method may include that the 3D coordinate measurement device transmits the first plurality of 3D coordinates and the second plurality of 3D coordinates to a cloud computing system via network.

In addition to one or more of the features described herein, or as an alternative, further embodiments of the method may include that the processing system transmits the first plurality of 3D coordinates and the second plurality of 3D coordinates to a cloud computing system.

In addition to one or more of the features described herein, or as an alternative, further embodiments of the method may include that the object is a geometric primitive.

In addition to one or more of the features described herein, or as an alternative, further embodiments of the method may include that the object is a planar surface.

In addition to one or more of the features described herein, or as an alternative, further embodiments of the method may include that the object is a curved surface.

In addition to one or more of the features described herein, or as an alternative, further embodiments of the method may include that the object is a free-form surface.

In addition to one or more of the features described herein, or as an alternative, further embodiments of the method may include that the distance is selected from the group consisting of a Euclidean distance, a Hamming distance, and a Manhattan distance.

In addition to one or more of the features described herein, or as an alternative, further embodiments of the method may include that the 3D coordinate measurement device is a laser scanner.

In addition to one or more of the features described herein, or as an alternative, further embodiments of the method may include that the laser scanner includes: a scanner processing system including a scanner controller; a housing; and a 3D scanner disposed within the housing and operably coupled to the scanner processing system, the 3D scanner having a light source, a beam steering unit, a first angle measuring device, a second angle measuring device, and a light receiver, the beam steering unit cooperating with the light source and the light receiver to define a scan area, the light source and the light receiver configured to cooperate with the scanner processing system to determine a first distance to a first object point based at least in part on a transmitting of a light by the light source and a receiving of a reflected light by the light receiver, the 3D scanner configured to cooperate with the scanner processing system to determine 3D coordinates of the first object point based at least in part on the first distance, a first angle of rotation, and a second angle of rotation.

According to an embodiment, a system for tracking an object is provided. The system includes a three-dimensional (3D) coordinate measurement device and a processing system having a display. The 3D coordinate measurement device captures point cloud data by performing a scan by performing a plurality of rotations about an axis during the scan. The 3D coordinate measurement device further captures point cloud data by capturing a plurality of 3D coordinates of the object during each of the plurality of rotations. The 3D coordinate measurement device further captures point cloud data by transmitting, to the processing system, a first plurality of 3D coordinates of the object captured during a first rotation of the plurality of rotations of the 3D coordinate measurement device, the processing system displaying the first plurality of 3D coordinates on the display. The 3D coordinate measurement device further captures point cloud data by transmitting, to the processing system, a second plurality of 3D coordinates of the object captured during a second rotation of the plurality of rotations of the 3D coordinate measurement device, the processing system displaying, on the display, the second plurality of 3D coordinates instead of the first plurality of 3D coordinates. The processing system analyzes the point cloud data by analyzing the point cloud data by comparing a point of the point cloud data to a corresponding reference point from reference data to determine a distance between the point and the corresponding reference point, wherein the point and the corresponding reference point are associated with the object. The processing system further analyzes the point cloud data by determining whether a change to a location of the object occurred by comparing the distance to a distance threshold. The processing system further analyzes the point cloud data by, responsive to determining that the change to the location of the object occurred, displaying a change indicium on the display.

In addition to one or more of the features described herein, or as an alternative, further embodiments of the system may include that the 3D coordinate measurement device transmits the first plurality of 3D coordinates and the second plurality of 3D coordinates to a cloud computing system via network.

In addition to one or more of the features described herein, or as an alternative, further embodiments of the system may include that the processing system transmits the first plurality of 3D coordinates and the second plurality of 3D coordinates to a cloud computing system.

In addition to one or more of the features described herein, or as an alternative, further embodiments of the system may include that the object is a geometric primitive.

In addition to one or more of the features described herein, or as an alternative, further embodiments of the system may include that the object is a planar surface.

In addition to one or more of the features described herein, or as an alternative, further embodiments of the system may include that the object is a curved surface.

In addition to one or more of the features described herein, or as an alternative, further embodiments of the system may include that the object is a free-form surface.

In addition to one or more of the features described herein, or as an alternative, further embodiments of the system may include that the distance is selected from the group consisting of a Euclidean distance, a Hamming distance, and a Manhattan distance.

In addition to one or more of the features described herein, or as an alternative, further embodiments of the system may include that the 3D coordinate measurement device is a laser scanner.

In addition to one or more of the features described herein, or as an alternative, further embodiments of the system may include that the laser scanner includes: a scanner processing system including a scanner controller; a housing; and a 3D scanner disposed within the housing and operably coupled to the scanner processing system, the 3D scanner having a light source, a beam steering unit, a first angle measuring device, a second angle measuring device, and a light receiver, the beam steering unit cooperating with the light source and the light receiver to define a scan area, the light source and the light receiver configured to cooperate with the scanner processing system to determine a first distance to a first object point based at least in part on a transmitting of a light by the light source and a receiving of a reflected light by the light receiver, the 3D scanner configured to cooperate with the scanner processing system to determine 3D coordinates of the first object point based at least in part on the first distance, a first angle of rotation, and a second angle of rotation.

The above features and advantages, and other features and advantages, of the disclosure are readily apparent from the following detailed description when taken in connection with the accompanying drawings.

### BRIEF DESCRIPTION OF DRAWINGS

The patent or application file contains at least one drawing executed in color. Copies of this patent or patent application publication with color drawing(s) will be provided by the Office upon request and payment of the necessary fee.

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a perspective view of a laser scanner according to one or more embodiments described herein;

FIG. 2 is a side view of the laser scanner illustrating a method of measurement according to one or more embodiments described herein;

FIG. 3 is a schematic illustration of the optical, mechanical, and electrical components of the laser scanner according to one or more embodiments described herein;

FIG. 4 is a schematic illustration of the laser scanner of FIG. 1 according to one or more embodiments described herein;

FIG. 5A is a schematic illustration of a floor of poured concrete to be scanned by the scanner of FIG. 1 according to one or more embodiments described herein;

FIG. 5B is a schematic illustration of a floor of poured concrete to be scanned by the scanner of FIG. 1 according to one or more embodiments described herein;

FIG. 6 is a schematic illustration of a processing system for determining floor flatness and levelness according to one or more embodiments described herein;

FIG. 7 is a flow diagram of a method for determining floor flatness and levelness according to one or more embodiments described herein;

FIG. 8 is a flow diagram of a method for determining floor flatness and levelness according to one or more embodiments described herein;

FIG. 9 is a flow diagram of a method for determining floor flatness and levelness according to one or more embodiments described herein;

FIG. 10 is a graphical representation of a floor flatness and levelness deviation according to one or more embodiments described herein;

FIG. 11 is another graphical representation of a floor flatness and levelness deviation according to one or more embodiments described herein

FIG. 12 is yet another graphical representation of a floor flatness and levelness deviation according to one or more embodiments described herein;

FIG. 13A is a block diagram of a system for performing object analysis according to one or more embodiments described herein;

FIG. 13B is a block diagram of a system for performing object analysis according to one or more embodiments described herein;

FIG. 14 is a method for performing a surface flatness analysis according to one or more embodiments described herein;

FIG. 15A is a diagram of environment to be scanned by a 3D coordinate measurement device according to one or more embodiments described herein;

FIG. 15B is a diagram of an interface for displaying results of a surface flatness analysis of the environment of FIG. 15A according to one or more embodiments described herein;

FIG. 15C is a diagram of environment to be scanned by a 3D coordinate measurement device according to one or more embodiments described herein;

FIG. 15D is a diagram of an interface for displaying results of a surface flatness analysis of the environment of FIG. 15C according to one or more embodiments described herein;

FIG. 16 is a flow diagram of a method for object tracking according to one or more embodiments described herein;

FIG. 17 is a flow diagram of a method for object tracking according to one or more embodiments described herein; and

FIG. 18 is a schematic illustration of a processing system for implementing the presently described techniques according to one or more embodiments described herein.

The detailed description explains embodiments of the disclosure, together with advantages and features, by way of example with reference to the drawings.

### DETAILED DESCRIPTION

Embodiments described herein provide for floor flatness and levelness determination using a laser scanner. Embodiments described herein additionally or alternatively provide for object tracking.

In the case of floor flatness and levelness, concrete is frequently used as flooring at warehouses, factories, and the like. During construction, wet concrete is poured and then manipulated (e.g., by hand, by automated machines, etc.) until it is flat and level within predetermined specifications. Once dry, the concrete is difficult to manipulate resulting in costly delays in reworking areas that are out of specification. Due to the nature of wet concrete and the typically large areas being poured, it is difficult to ensure flat and level floors to acceptable levels, especially where floor flatness and levelness is held to tight specifications.

Floor flatness refers to the change in elevation difference between two consecutive measurements of elevation difference each measured over a certain distance. Floor levelness refers to the difference in elevation between two opposing points a certain distance apart. Although embodiments described herein refer to a “floor” of an environment, it should be appreciated that the techniques described herein can be applied to any substantially planar surface.

Various international guidelines set forth standards for floor flatness and levelness. Examples include, but are not limited to: American Society for Testing and Materials (ASTM) E1155 “Standard Test Method for Determining FF Floor Flatness and FL Floor Levelness Numbers” (ASTM E1155); The Concrete Society's (CS) TR34 Free Movement (4th Edition) Classifications (CS TR34); and Deutsches Institut ftir Normung (DIN), the German standard (DIN18202). Floors that are not within the standards for flatness and levelness can cause poor drainage, navigability issues (e.g., by machinery, robots, etc.), instability for fixtures (e.g., machinery, forklifts, shelving racks, etc.).

Conventional approaches for floor flatness and levelness determination are time consuming and expensive. For example, conventional floor flatness and levelness determination often involves using a straightedge & wedge approach, using a dipstick/floor profiler, or using an optical level and parallel plate micrometer to take readings. These approaches are time consuming, prone to error, expensive, and can only be performed on dry concrete.

The present techniques provide improved floor flatness and levelness determination provide by using scan data obtained by one or more laser scanners. For example, a section of concrete slab flooring is scanned by one or more laser scanners. Scan data collected by the one or more laser scanners is analyzed and compared to a selected standard or build requirement, and out-of-tolerance (i.e., defective) areas are determined. Areas that are out-of-tolerance can then be corrected, such as by adding or removing material to cause the floor to be within a desired tolerance for flatness and levelness.

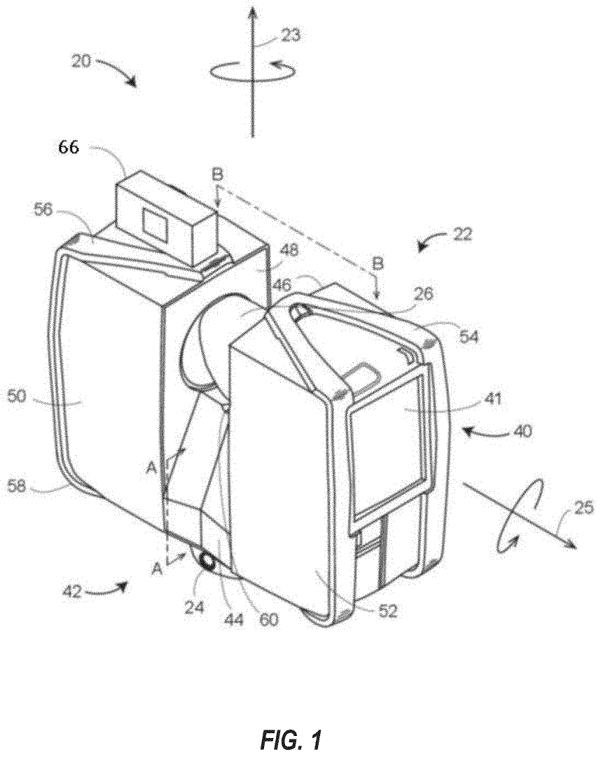

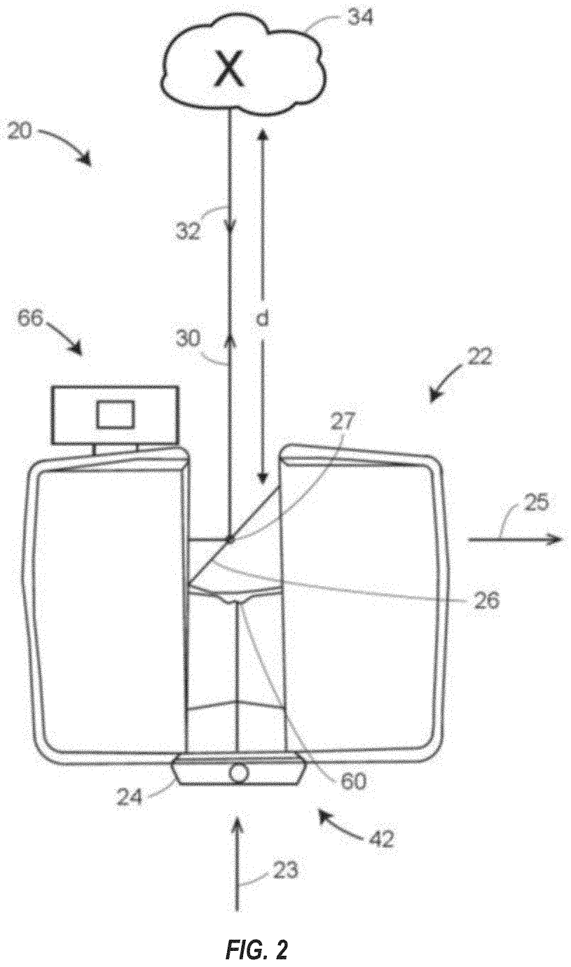

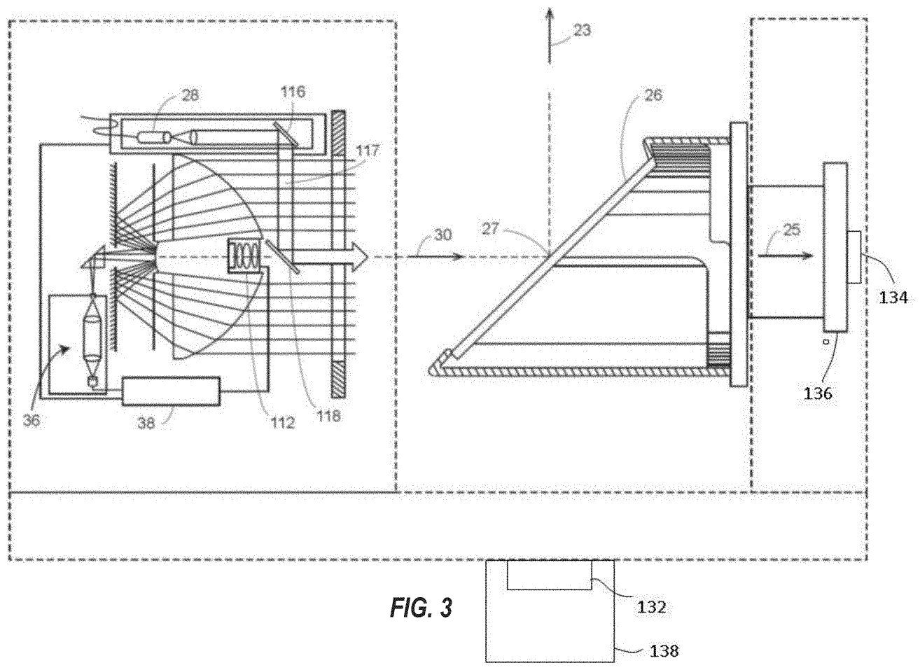

Referring now to FIGS. 1-3, a laser scanner 20 is shown for optically scanning and measuring the environment surrounding the laser scanner 20 according to one or more embodiments described herein. The laser scanner 20 has a measuring head 22 and a base 24. The measuring head 22 is mounted on the base 24 such that the laser scanner 20 may be rotated about a vertical axis 23. In one embodiment, the measuring head 22 includes a gimbal point 27 that is a center of rotation about the vertical axis 23 and a horizontal axis 25. The measuring head 22 has a rotary mirror 26, which may be rotated about the horizontal axis 25. The rotation about the vertical axis may be about the center of the base 24. The terms vertical axis and horizontal axis refer to the scanner in its normal upright position. It is possible to operate a 3D coordinate measurement device on its side or upside down, and so to avoid confusion, the terms azimuth axis and zenith axis may be substituted for the terms vertical axis and horizontal axis, respectively. The term pan axis or standing axis may also be used as an alternative to vertical axis.

The measuring head 22 is further provided with an electromagnetic radiation emitter, such as light emitter 28, for example, that emits an emitted light beam 30. In one embodiment, the emitted light beam 30 is a coherent light beam such as a laser beam. The laser beam may have a wavelength range of approximately 300 to 1600 nanometers, for example 790 nanometers, 905 nanometers, 1550 nm, or less than 400 nanometers. It should be appreciated that other electromagnetic radiation beams having greater or smaller wavelengths may also be used. The emitted light beam 30 is amplitude or intensity modulated, for example, with a sinusoidal waveform or with a rectangular waveform. The emitted light beam 30 is emitted by the light emitter 28 onto a beam steering unit, such as mirror 26, where it is deflected to the environment. A reflected light beam 32 is reflected from the environment by an object 34. The reflected or scattered light is intercepted by the rotary mirror 26 and directed into a light receiver 36. The directions of the emitted light beam 30 and the reflected light beam 32 result from the angular positions of the rotary mirror 26 and the measuring head 22 about the axes 25 and 23, respectively. These angular positions in turn depend on the corresponding rotary drives or motors.

Coupled to the light emitter 28 and the light receiver 36 is a controller 38. The controller 38 determines, for a multitude of measuring points X, a corresponding number of distances d between the laser scanner 20 and the points X on object 34. The distance to a particular point X is determined based at least in part on the speed of light in air through which electromagnetic radiation propagates from the device to the object point X. In one embodiment the phase shift of modulation in light emitted by the laser scanner 20 and the point X is determined and evaluated to obtain a measured distance d.

The speed of light in air depends on the properties of the air such as the air temperature, barometric pressure, relative humidity, and concentration of carbon dioxide. Such air properties influence the index of refraction n of the air. The speed of light in air is equal to the speed of light in vacuum c divided by the index of refraction. In other words, cₐᵢᵣ=c/n. A laser scanner of the type discussed herein is based on the time-of-flight (TOF) of the light in the air (the round-trip time for the light to travel from the device to the object and back to the device). Examples of TOF scanners include scanners that measure round trip time using the time interval between emitted and returning pulses (pulsed TOF scanners), scanners that modulate light sinusoidally and measure phase shift of the returning light (phase-based scanners), as well as many other types. A method of measuring distance based on the time-of-flight of light depends on the speed of light in air and is therefore easily distinguished from methods of measuring distance based on triangulation. Triangulation-based methods involve projecting light from a light source along a particular direction and then intercepting the light on a camera pixel along a particular direction. By knowing the distance between the camera and the projector and by matching a projected angle with a received angle, the method of triangulation enables the distance to the object to be determined based on one known length and two known angles of a triangle. The method of triangulation, therefore, does not directly depend on the speed of light in air.

In one mode of operation, the scanning of the volume around the laser scanner 20 takes place by rotating the rotary mirror 26 relatively quickly about axis 25 while rotating the measuring head 22 relatively slowly about axis 23, thereby moving the assembly in a spiral pattern. In an exemplary embodiment, the rotary mirror rotates at a maximum speed of 5820 revolutions per minute. For such a scan, the gimbal point 27 defines the origin of the local stationary reference system. The base 24 rests in this local stationary reference system.

In addition to measuring a distance d from the gimbal point 27 to an object point X, the scanner 20 may also collect gray-scale information related to the received optical power (equivalent to the term “brightness.”) The gray-scale value may be determined at least in part, for example, by integration of the bandpass-filtered and amplified signal in the light receiver 36 over a measuring period attributed to the object point X.

The measuring head 22 may include a display device 40 integrated into the laser scanner 20. The display device 40 may include a graphical touch screen 41, as shown in FIG. 1, which allows the operator to set the parameters or initiate the operation of the laser scanner 20. For example, the screen 41 may have a user interface that allows the operator to provide measurement instructions to the device, and the screen may also display measurement results.

The laser scanner 20 includes a carrying structure 42 that provides a frame for the measuring head 22 and a platform for attaching the components of the laser scanner 20. In one embodiment, the carrying structure 42 is made from a metal such as aluminum. The carrying structure 42 includes a traverse member 44 having a pair of walls 46, 48 on opposing ends. The walls 46, 48 are parallel to each other and extend in a direction opposite the base 24. Shells 50, 52 are coupled to the walls 46, 48 and cover the components of the laser scanner 20. In the exemplary embodiment, the shells 50, 52 are made from a plastic material, such as polycarbonate or polyethylene for example. The shells 50, 52 cooperate with the walls 46, 48 to form a housing for the laser scanner 20.

On an end of the shells 50, 52 opposite the walls 46, 48 a pair of yokes 54, 56 are arranged to partially cover the respective shells 50, 52. In the exemplary embodiment, the yokes 54, 56 are made from a suitably durable material, such as aluminum for example, that assists in protecting the shells 50, 52 during transport and operation. The yokes 54, 56 each includes a first arm portion 58 that is coupled, such as with a fastener for example, to the traverse 44 adjacent the base 24. The arm portion 58 for each yoke 54, 56 extends from the traverse 44 obliquely to an outer corner of the respective shell 50, 52. From the outer corner of the shell, the yokes 54, 56 extend along the side edge of the shell to an opposite outer corner of the shell. Each yoke 54, 56 further includes a second arm portion that extends obliquely to the walls 46, 48. It should be appreciated that the yokes 54, 56 may be coupled to the traverse 42, the walls 46, 48 and the shells 50, 54 at multiple locations.

The pair of yokes 54, 56 cooperate to circumscribe a convex space within which the two shells 50, 52 are arranged. In the exemplary embodiment, the yokes 54, 56 cooperate to cover all of the outer edges of the shells 50, 54, while the top and bottom arm portions project over at least a portion of the top and bottom edges of the shells 50, 52. This provides advantages in protecting the shells 50, 52 and the measuring head 22 from damage during transportation and operation. In other embodiments, the yokes 54, 56 may include additional features, such as handles to facilitate the carrying of the laser scanner 20 or attachment points for accessories for example.

On top of the traverse 44, a prism 60 is provided. The prism extends parallel to the walls 46, 48. In the exemplary embodiment, the prism 60 is integrally formed as part of the carrying structure 42. In other embodiments, the prism 60 is a separate component that is coupled to the traverse 44. When the mirror 26 rotates, during each rotation the mirror 26 directs the emitted light beam 30 onto the traverse 44 and the prism 60. Due to non-linearities in the electronic components, for example in the light receiver 36, the measured distances d may depend on signal strength, which may be measured in optical power entering the scanner or optical power entering optical detectors within the light receiver 36, for example. In an embodiment, a distance correction is stored in the scanner as a function (possibly a nonlinear function) of distance to a measured point and optical power (generally unscaled quantity of light power sometimes referred to as “brightness”) returned from the measured point and sent to an optical detector in the light receiver 36. Since the prism 60 is at a known distance from the gimbal point 27, the measured optical power level of light reflected by the prism 60 may be used to correct distance measurements for other measured points, thereby allowing for compensation to correct for the effects of environmental variables such as temperature. In the exemplary embodiment, the resulting correction of distance is performed by the controller 38.

In an embodiment, the base 24 is coupled to a swivel assembly (not shown) such as that described in commonly owned U.S. Pat. No. 8,705,012 ('012), which is incorporated by reference herein. The swivel assembly is housed within the carrying structure 42 and includes a motor 138 that is configured to rotate the measuring head 22 about the axis 23. In an embodiment, the angular/rotational position of the measuring head 22 about the axis 23 is measured by angular encoder 134.

An auxiliary image acquisition device 66 may be a device that captures and measures a parameter associated with the scanned area or the scanned object and provides a signal representing the measured quantities over an image acquisition area. The auxiliary image acquisition device 66 may be, but is not limited to, a pyrometer, a thermal imager, an ionizing radiation detector, or a millimeter-wave detector. In an embodiment, the auxiliary image acquisition device 66 is a color camera.

In an embodiment, a central color camera (first image acquisition device) 112 is located internally to the scanner and may have the same optical axis as the 3D scanner device. In this embodiment, the first image acquisition device 112 is integrated into the measuring head 22 and arranged to acquire images along the same optical pathway as emitted light beam 30 and reflected light beam 32. In this embodiment, the light from the light emitter 28 reflects off a fixed mirror 116 and travels to dichroic beam-splitter 118 that reflects the light 117 from the light emitter 28 onto the rotary mirror 26. In an embodiment, the mirror 26 is rotated by a motor 136 and the angular/rotational position of the mirror is measured by angular encoder 134. The dichroic beam-splitter 118 allows light to pass through at wavelengths different than the wavelength of light 117. For example, the light emitter 28 may be a near infrared laser light (for example, light at wavelengths of 780 nm or 1150 nm), with the dichroic beam-splitter 118 configured to reflect the infrared laser light while allowing visible light (e.g., wavelengths of 400 to 700 nm) to transmit through. In other embodiments, the determination of whether the light passes through the beam-splitter 118 or is reflected depends on the polarization of the light. The digital camera 112 obtains 2D images of the scanned area to capture color data to add to the scanned image. In the case of a built-in color camera having an optical axis coincident with that of the 3D scanning device, the direction of the camera view may be easily obtained by simply adjusting the steering mechanisms of the scanner—for example, by adjusting the azimuth angle about the axis 23 and by steering the mirror 26 about the axis 25.

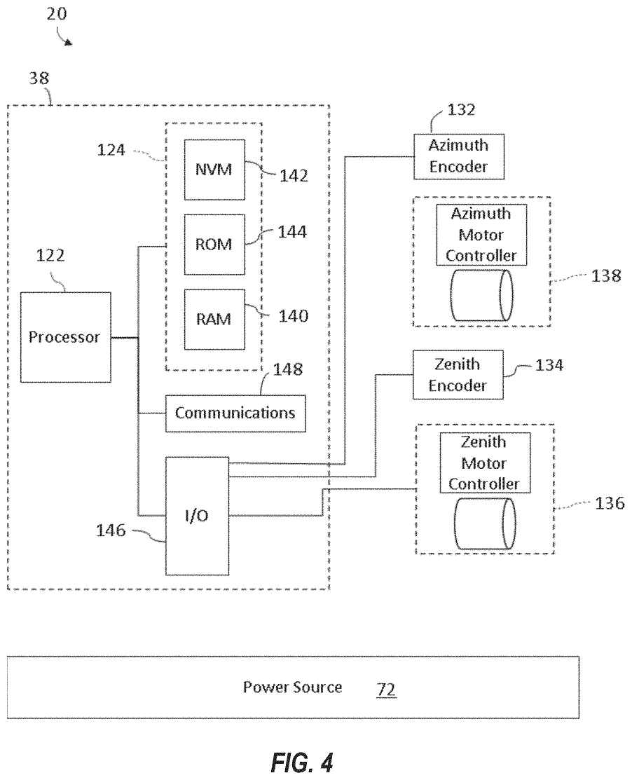

Referring now to FIG. 4 with continuing reference to FIGS. 1-3, elements are shown of the laser scanner 20. Controller 38 is a suitable electronic device capable of accepting data and instructions, executing the instructions to process the data, and presenting the results. The controller 38 includes one or more processing elements 122. The processors may be microprocessors, field programmable gate arrays (FPGAs), digital signal processors (DSPs), and generally any device capable of performing computing functions. The one or more processors 122 have access to memory 124 for storing information.

Controller 38 is capable of converting the analog voltage or current level provided by light receiver 36 into a digital signal to determine a distance from the laser scanner 20 to an object in the environment. Controller 38 uses the digital signals that act as input to various processes for controlling the laser scanner 20. The digital signals represent one or more laser scanner 20 data including but not limited to distance to an object, images of the environment, images acquired by panoramic camera 126, angular/rotational measurements by a first or azimuth encoder 132, and angular/rotational measurements by a second axis or zenith encoder 134.

In general, controller 38 accepts data from encoders 132, 134, light receiver 36, light source 28, and panoramic camera 126 and is given certain instructions for the purpose of generating a 3D point cloud of a scanned environment. Controller 38 provides operating signals to the light source 28, light receiver 36, panoramic camera 126, zenith motor 136 and azimuth motor 138. The controller 38 compares the operational parameters to predetermined variances and if the predetermined variance is exceeded, generates a signal that alerts an operator to a condition. The data received by the controller 38 may be displayed on a user interface 40 coupled to controller 38. The user interface 40 may be one or more LEDs (light-emitting diodes) 82, an LCD (liquid-crystal diode) display, a CRT (cathode ray tube) display, a touch-screen display or the like. A keypad may also be coupled to the user interface for providing data input to controller 38. In one embodiment, the user interface is arranged or executed on a mobile computing device that is coupled for communication, such as via a wired or wireless communications medium (e.g. Ethernet, serial, USB, Bluetooth™ or WiFi) for example, to the laser scanner 20.

The controller 38 may also be coupled to external computer networks such as a local area network (LAN) and the Internet. A LAN interconnects one or more remote computers, which are configured to communicate with controller 38 using a well-known computer communications protocol such as TCP/IP (Transmission Control Protocol/Internet(\hat{ }) Protocol), RS-232, ModBus, and the like. Additional systems 20 may also be connected to LAN with the controllers 38 in each of these systems 20 being configured to send and receive data to and from remote computers and other systems 20. The LAN may be connected to the Internet. This connection allows controller 38 to communicate with one or more remote computers connected to the Internet.

The processors 122 are coupled to memory 124. The memory 124 may include random access memory (RAM) device 140, a non-volatile memory (NVM) device 142, and a read-only memory (ROM) device 144. In addition, the processors 122 may be connected to one or more input/output (I/O) controllers 146 and a communications circuit 148. In an embodiment, the communications circuit 92 provides an interface that allows wireless or wired communication with one or more external devices or networks, such as the LAN discussed above.

Controller 38 includes operation control methods embodied in application code (e.g., program instructions executable by a processor to cause the processor to perform operations). These methods are embodied in computer instructions written to be executed by processors 122, typically in the form of software. The software can be encoded in any language, including, but not limited to, assembly language, VHDL (Verilog Hardware Description Language), VHSIC HDL (Very High Speed IC Hardware Description Language), Fortran (formula translation), C, C++, C#, Objective-C, Visual C++, Java, ALGOL (algorithmic language), BASIC (beginners all-purpose symbolic instruction code), visual BASIC, ActiveX, HTML (HyperText Markup Language), Python, Ruby and any combination or derivative of at least one of the foregoing.

According to one or more embodiments, the controller 38 can be communicatively coupled to or otherwise include an inertial measurement unit (IMU) (not shown). For example, the laser scanner 20 can include elements of an IMU, namely accelerometers and gyroscopes, and may in addition include magnetometers, pressure sensors, and global positioning systems (GPS). Accelerometers, which also serve as inclinometers, may be three-axis accelerometers that provide acceleration and inclination information in three dimensions. Gyroscopes may be three-axis gyroscopes that measure rotational velocity in three dimensions. Magnetometers provide heading information, that is, information about changes in direction in a plane perpendicular to the gravity vector. Because magnetometers are affected by magnetic fields, their performance may be compromised in industrial environments by the relatively large magnetic fields generated by motors and other industrial equipment. Pressure sensors, which also serve as altimeters, may be used to determine elevation, for example, to determine a number of a floor within a multi-story building. GPS sensors and other related sensors such as GLONASS measure locations anywhere on earth. Accuracy of such sensors varies widely depending on the implementation. A potential problem with GPS is the potential for it being blocked inside buildings. Indoor GPS, which does not actually use the global positioning system, is becoming available in different forms today to provide location information when GPS is blocked by buildings. The sensors described hereinabove may be used separately or combined together in a single laser scanner (e.g., the laser scanner 20). The data provided multiple sensors within a laser scanner may be processed using Kalman filters and/or other mathematical techniques to improve calculated values for position and orientation of the laser scanner over time.

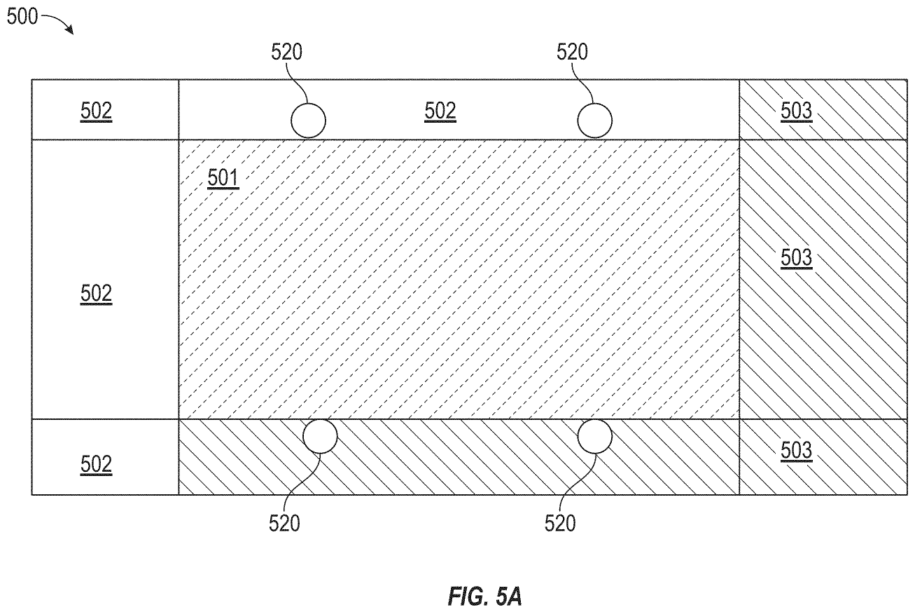

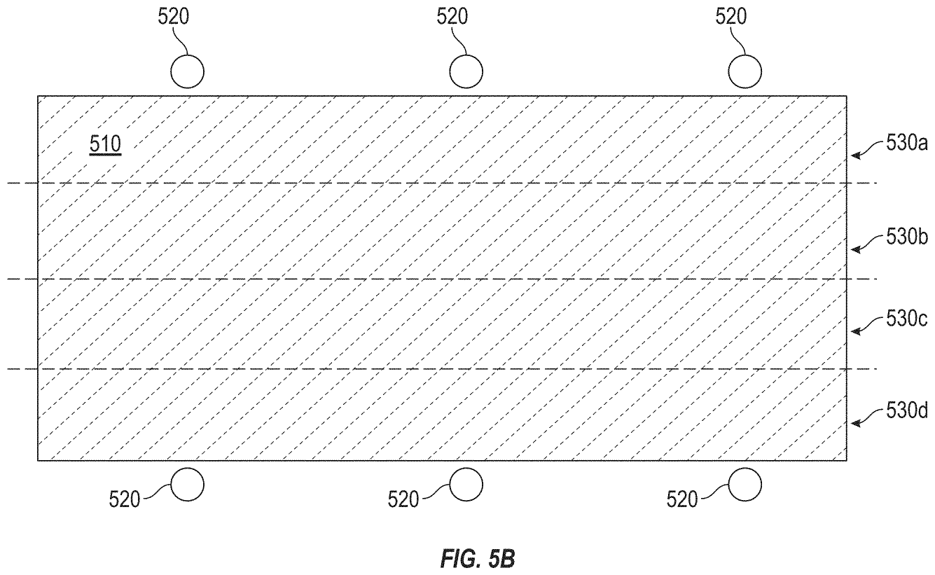

FIG. 5A is a schematic illustration of a floor 500 of poured concrete to be scanned by the scanner of FIG. 1 according to one or more embodiments described herein. The floor 500 is divided into sections 501, 502, 503 as shown, with each section 501-503 of the floor 500 having concrete poured thereinto. It is useful to divide the floor 500 into section 501-503 to reduce the area of wet concrete being worked at any point. Thus, the size of each of the sections 501-503 can be determined based at least in part, for example, on how much material is available, how many people/machines are available to work the concrete, an estimated drying time of the concrete, a slump of the concrete, resistance to cracking, and/or other variables/parameters. In the example of FIG. 5A, the section 501 is a section of wet concrete that has recently been poured and has not yet finished drying. Thus, the concrete in the section 501 can still be worked. The sections 502 have not yet been poured, and the sections 503 have already been poured and are dry/drying/cured. It may be desirable to scan the wet concrete in section 501 to determine a floor flatness and levelness deviation relative to a predetermined tolerance before the concrete dries. This enables such deviations to be corrected before the concrete dries, saving significant time and effort.

However, in some cases, it may be desirable to scan a concrete floor that is cured/dry (e.g., an existing floor). FIG. 5B is a schematic illustration of a floor 510 of poured concrete to be scanned by the scanner of FIG. 1 according to one or more embodiments described herein.

One or more laser scanners 520 (e.g., the laser scanner 20) can be arranged on or around the section 501 to scan the section 501. One such arrangement is as shown in FIG. 5A, although other arrangements and other numbers of laser scanners are also possible. Similarly, one or more laser scanners 520 can be arranged on or around the floor 510 to scan the floor 510. One such arrangement is as shown in FIG. 5B, although other arrangements and other numbers of laser scanners are also possible. It should be appreciated that in some embodiments, the operator may have a single scanner 520 that is moved between locations to scan a desired area with no occlusions.

According to one or more embodiments described herein, the laser scanners 520 can include a scanner processing system including a scanner controller, a housing, and a three-dimensional (3D) scanner. The 3D scanner can be disposed within the housing and operably coupled to the scanner processing system. The 3D scanner includes a light source, a beam steering unit, a first angle measuring device, a second angle measuring device, and a light receiver. The beam steering unit cooperates with the light source and the light receiver to define a scan area. The light source and the light receiver are configured to cooperate with the scanner processing system to determine a first distance to a first object point based at least in part on a transmitting of a light by the light source and a receiving of a reflected light by the light receiver. The 3D scanner is further configured to cooperate with the scanner processing system to determine 3D coordinates of the first object point based at least in part on the first distance, a first angle of rotation, and a second angle of rotation.

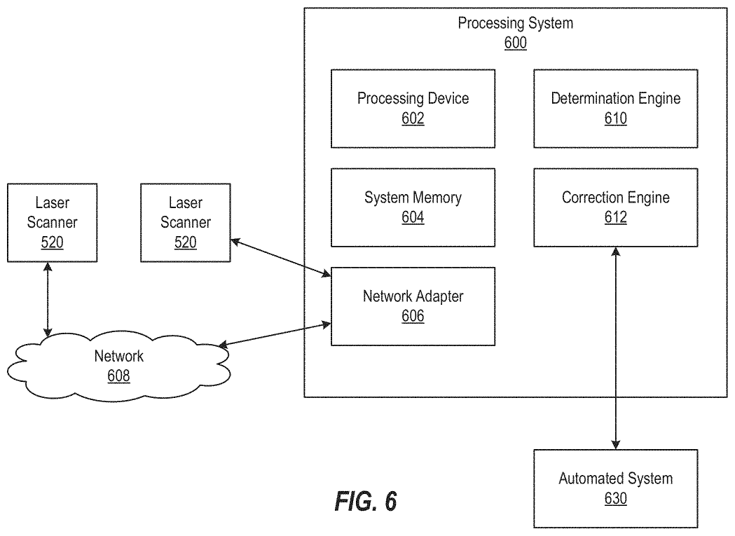

The laser scanners 520 perform at least one scan to generate a data set that includes a plurality of three-dimensional coordinates of the floor (particularly the section 501 of the floor 500). The data set can be transmitted, directly or indirectly (such as via a network) to a processing system, such as the processing system 600 shown in FIG. 6.

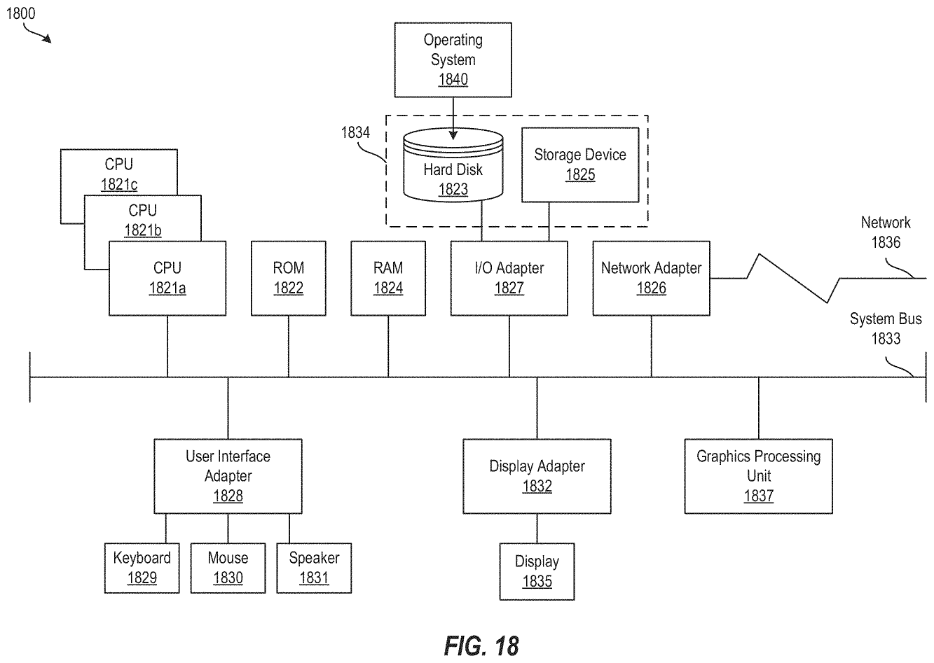

In particular, FIG. 6 is a schematic illustration of a processing system 600 for determining floor flatness and levelness according to one or more embodiments described herein. The processing system 600 includes a processing device 602 (e.g., one or more of the processing devices 1821 of FIG. 18), a system memory 604 (e.g., the RAM 1824 and/or the ROM 1622 of FIG. 18), a network adapter 606 (e.g., the network adapter 1826 of FIG. 18), a determination engine 610, and a correction engine 612.

The various components, modules, engines, etc. described regarding FIG. 6, such as the determination engine 610 and the correction engine 612, can be implemented as instructions stored on a computer-readable storage medium, as hardware modules, as special-purpose hardware (e.g., application specific hardware, application specific integrated circuits (ASICs), application specific special processors (ASSPs), field programmable gate arrays (FPGAs), as embedded controllers, hardwired circuitry, etc.), or as some combination or combinations of these. According to aspects of the present disclosure, the engine(s) described herein can be a combination of hardware and programming The programming can be processor executable instructions stored on a tangible memory, and the hardware can include the processing device 602 for executing those instructions. Thus the system memory 604 can store program instructions that when executed by the processing device 602 implement the engines described herein. Other engines can also be utilized to include other features and functionality described in other examples herein.

The network adapter 606 enables the processing system 600 to transmit data to and/or receive data from other sources, such as the laser scanners 520. For example, the processing system 600 receives data (e.g., a data set that includes a plurality of three-dimensional coordinates of a floor 510 and/or of the section 501) from the laser scanners 520 directly and/or via a network 608.

The network 608 represents any one or a combination of different types of suitable communications networks such as, for example, cable networks, public networks (e.g., the Internet), private networks, wireless networks, cellular networks, or any other suitable private and/or public networks. Further, the network 608 can have any suitable communication range associated therewith and may include, for example, global networks (e.g., the Internet), metropolitan area networks (MANs), wide area networks (WANs), local area networks (LANs), or personal area networks (PANs). In addition, the network 608 can include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof.

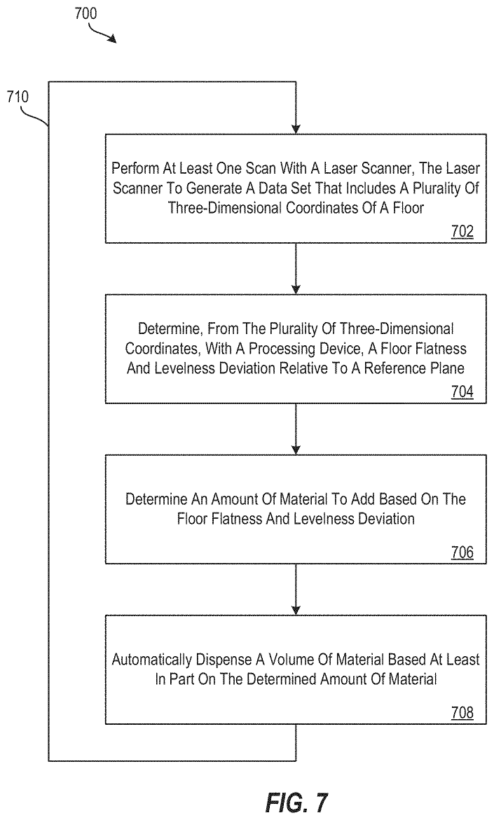

Using the data received from the laser scanners 520, the processing system 600 can determine, using the determination engine 610, a floor flatness and levelness deviation and can correct, using the correction engine 612, a defect associated with the determined floor flatness and levelness deviation. For example, the correction engine 612 can control an automated system 630, for example, to correct a defect associated with the floor flatness and levelness deviation, to dispense a volume of material, and the like. In an embodiment, the volume of material is dispensed automatically. The features and functionality of the determination engine 610 and the correction engine 612 are now described in more detail with reference to the methods depicted in FIGS. 7, 8, and 9.

FIG. 7 depicts a flow diagram of a method 700 for determining floor flatness and levelness according to one or more embodiments described herein. The method 700 can be performed by any suitable system or device, such as the processing system 600 of FIG. 6 and/or the processing system 1800 of FIG. 18.

At block 702, a laser scanner (e.g., the laser scanner 520) performs at least one scan of a floor (e.g., the section 501, the floor 510, etc.). The laser scanner 520 generates a data set that includes a plurality of three-dimensional (3D) coordinates of a floor. In examples, the data set can be a 3D mesh or point cloud representation of the scanned floor. The data set is transferred to a processing system (e.g., the processing system 600).

At block 704, the processing system 600, using the determination engine 610, determines, from the plurality of three-dimensional coordinates, a floor flatness and levelness deviation relative to a reference plane. The reference plane can be defined based at least in part on a reference point located on or adjacent to the floor or section of floor. For example, the reference point can define a height (e.g., a finished floor height or other known/specified height). A physical identifier (e.g., a surveyors mark) can be positioned on or adjacent to the floor or section of floor to act as a reference marker. A reference plane is then defined based on the reference point. The floor flatness and levelness deviation is a measurement that indicates how much deviation (e.g., distance) exists between a point from the plurality of 3D coordinates and a corresponding point on the reference plane. The determination engine 610 can compare the floor flatness and levelness deviation to a standard (e.g., ASTM E1155, CS TR34, DIN18202, etc.), design specification, or other guideline to determine whether the deviation is acceptable or unacceptable. An acceptable floor flatness and levelness deviation has a value between the point from the plurality of 3D coordinates and the corresponding point on the reference plane that satisfies the standard, design specification, or other guideline. An unacceptable floor flatness and levelness deviation has a value that falls outside the standard, design specification, or other guideline. For each of the plurality of 3D coordinates, the floor flatness and levelness deviation can be a positive value, which indicates that the floor is above the reference plane at this point, or a negative value, which indicates that the floor is below the reference plane at this point. In some examples, the standard, design specification, or other guideline defines one or more thresholds (also referred to as “deviation thresholds”) such that values for points on the floor failing to satisfy a threshold may be deemed unacceptable. As an example, high and low thresholds can be defined, where points having a value above the high threshold or below the low threshold are deemed unacceptable.

At block 706, the processing system 600, using the correction engine 612, determining an amount of material to add based on the floor flatness and levelness deviation. For example, for a point or plurality of points determined to be unsatisfactory because the point or plurality of points are below the low threshold. This may indicate a low spot on the floor, which can lead to problems such as poor drainage (e.g., pooling), uneven surfaces for machines or vehicles to traverse, etc. The determination engine 610 can determine how much material (e.g., filler material) to add at the point or plurality of points to bring the low spot up to an acceptable value. For example, for a plurality of points, it may be determined that approximately 0.5 liters of filler material is needed.

At block 708, a volume of material is automatically dispensed at least in part on the determined amount of material. This can include a system or machine containing filler material to be instructed to dispense the volume of material into a container, which can then be applied to the low spot. In another example, an automated leveling system can be instructed to dispense the volume of material directly to the floor to fill in the low spot.

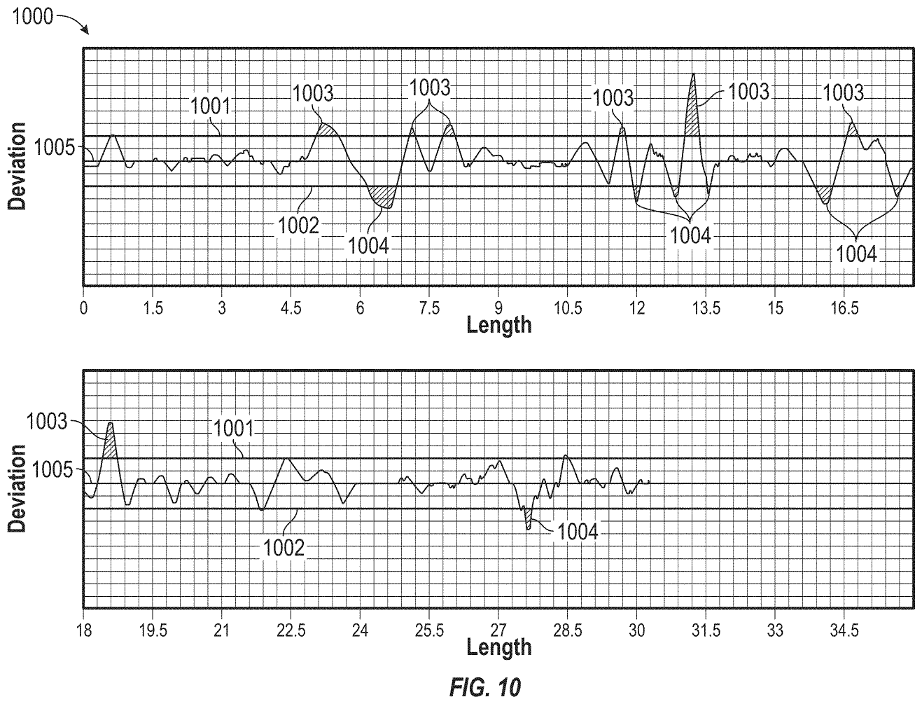

Additional processes also may be included. For example, the method 700 can include defining one or more two-dimensional longitudinal sections extending along a length of the floor. As shown in FIG. 5B, two-dimensional longitudinal sections 530a, 530b, 530c, 530d, may be arranged in parallel and spaced periodically or aperiodically along the width of and perpendicular to the floor. In an embodiment, the location of the two-dimensional longitudinal sections may be predetermined based on an attribute of the floor, such as being aligned with, or perpendicular to, where aisle ways will be located. The method 700 can then include determining, from the plurality of three-dimensional coordinates, a plurality of floor flatness and levelness deviations relative to the reference plane along each section of the floor. The method 700 can then include displaying, on a computer display, the plurality of floor flatness and levelness deviations as a function of distance relative to an origin of the section along the section. For example, FIG. 10 is a graphical representation 1000 of a floor flatness and levelness deviation according to one or more embodiments described herein. The graphical representation 1000 depicts the floor flatness and levelness deviation for one section extending along the length of the floor relative to a reference plane 1005. The graphical representation 1000 plots the deviation (vertical axis) against length (horizontal axis) as shown. The graphical representation 1000 also shows a high threshold 1001 and a low threshold 1002, where deviations above the high threshold are high points 1003 and where deviations below the low threshold are low points 1004. With continued reference to FIG. 7, the method 700 can include saving the plurality of floor flatness and levelness deviations as a function of distance to a memory (e.g., the system memory 604).

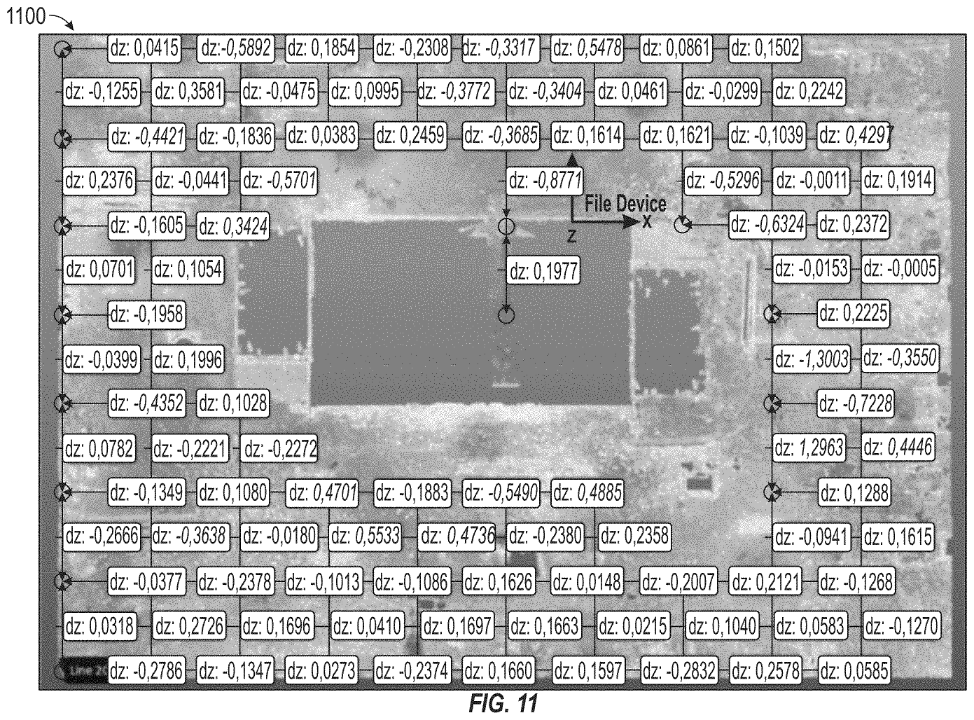

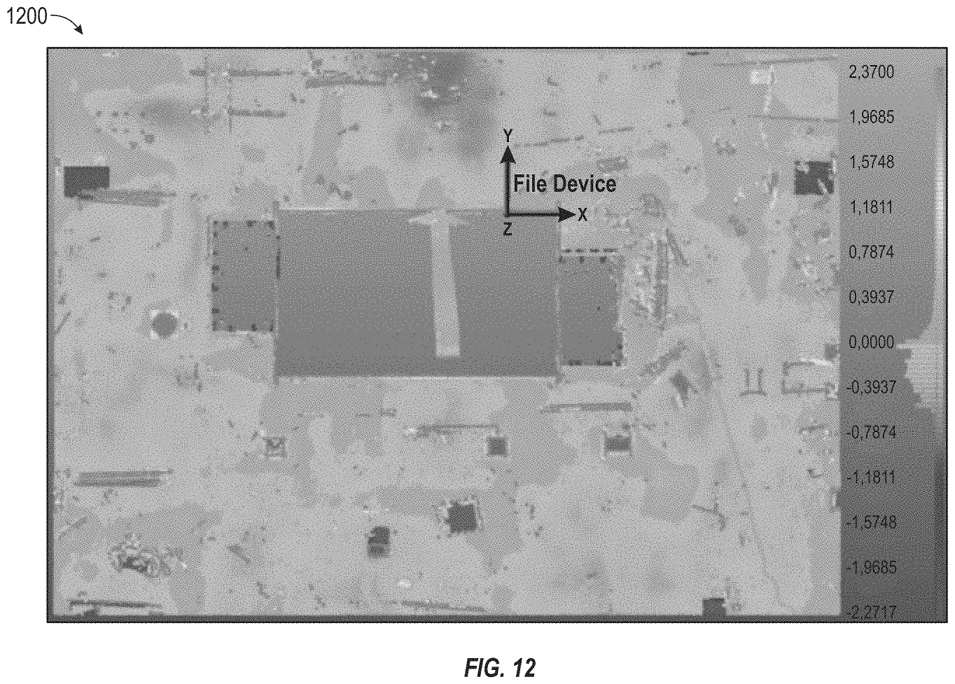

According to one or more embodiments described herein, the method 700 can generate, on a display of a user device, an augmented reality element and can display the floor flatness and levelness deviation in the augmented reality element. Augmented reality (AR) provides for enhancing the real physical world by delivering digital visual elements, sound, or other sensory stimuli (an “AR element”) via technology. For example, a user device (e.g., a smartphone, tablet computer, head-up display, etc.) equipped with a camera and display can be used to capture an image of an environment. In some cases, this includes using the camera to capture a live, real-time representation of an environment and displaying that representation on the display. An AR element can be displayed on the display and can be associated with an object/feature of the environment. For example, an AR element with information about how to operate a particular piece of equipment can be associated with that piece of equipment and can be digitally displayed on the display of the user device when the user device's camera captures the environment and displays it on the display. As another example, a floor flatness and levelness deviation relative to the predetermined tolerance can be included in an AR element. The AR element can display the floor flatness and levelness deviation as a function of distance. For example, the AR element can include the graphical representation 1000 of FIG. 10 or the graphical representation 1100 of FIG. 11, which shows the floor flatness and levelness deviation values for points of the plurality of three-dimensional coordinates of the floor. As another example, the AR element can display the floor flatness and levelness deviation as a heatmap. For example, the AR element can include the graphical representation 1200 of FIG. 12, which is a heatmap of a floor. Different colors can be used to depict the floor flatness and levelness deviation. For example, green can indicate that a value for the floor flatness and levelness deviation is acceptable while red can indicate that a value for the floor flatness and levelness deviation is unacceptable. Other colors can also be included and can show varying deviations.

In one or more embodiments, the method 700 can be performed iteratively, as shown by the arrow 710, such than a new scan can be performed and the new scan data can be analyzed in accordance with blocks 702, 704, 706, 708. In an embodiment, the areas of the floor where the deviation exceeds the tolerance are re-worked prior to acquiring the new scan data.

It should be understood that the process depicted in FIG. 7 represents an illustration, and that other processes may be added or existing processes may be removed, modified, or rearranged without departing from the scope of the present disclosure.

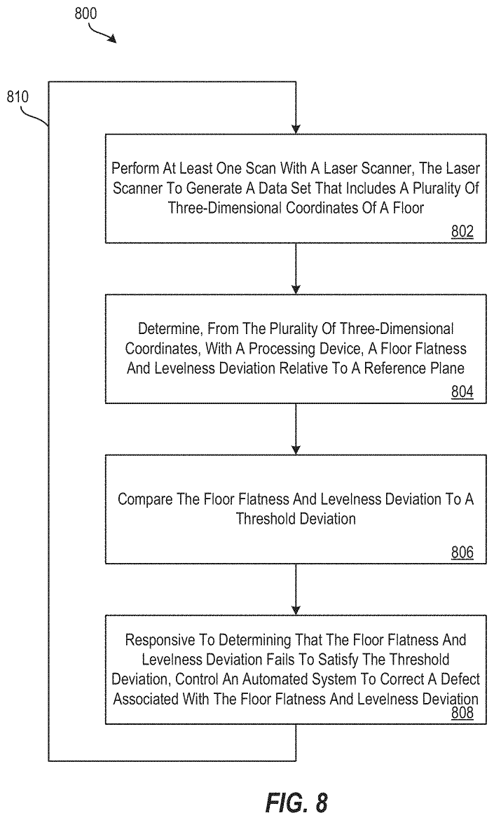

FIG. 8 depicts a flow diagram of a method 800 for determining floor flatness and levelness according to one or more embodiments described herein. The method 800 can be performed by any suitable system or device, such as the processing system 600 of FIG. 6 and/or the processing system 1800 of FIG. 18.

At block 802, a laser scanner (e.g., the laser scanner 520) performs at least one scan of a floor (e.g., the section 501, the floor 510, etc.). The laser scanner 520 generates a data set that includes a plurality of three-dimensional (3D) coordinates of a floor. In examples, the data set can be a 3D mesh or point cloud representation of the scanned floor. The data set is transferred to a processing system (e.g., the processing system 600).

At block 804, the processing system 600, using the determination engine 610, determines, from the plurality of three-dimensional coordinates a floor flatness and levelness deviation relative to a reference plane. The reference plane can be defined based at least in part on a reference point located on or adjacent to the floor or section of floor. For example, the reference point can define a height (e.g., a finished floor height or other known/specified height). A physical identifier can be positioned on or adjacent to the floor or section of floor to act as a reference marker. A reference plane is then defined based on the reference point. The floor flatness and levelness deviation is a measurement that indicates how much deviation (e.g., distance) exists between a point from the plurality of 3D coordinates and a corresponding point on the reference plane. The determination engine 610 can compare the floor flatness and levelness deviation to a standard (e.g., AS TM E1155, CS TR34, DIN18202, etc.), design specification, or other guideline to determine whether the deviation is acceptable or unacceptable. An acceptable floor flatness and levelness deviation has a value between the point from the plurality of 3D coordinates and the corresponding point on the reference plane that satisfies the standard, design specification, or other guideline. An unacceptable floor flatness and levelness deviation has a value that falls outside the standard, design specification, or other guideline. For each of the plurality of 3D coordinates, the floor flatness and levelness deviation can be a positive value, which indicates that the floor is above the reference plane at this point, or a negative value, which indicates that the floor is below the reference plane at this point. In some examples, the standard, design specification, or other guideline defines one or more tolerances or thresholds (also referred to as “deviation thresholds”) such that values for points on the floor failing to satisfy a threshold may be deemed unacceptable. As an example, high and low thresholds can be defined, where points having a value above the high threshold or below the low threshold are deemed unacceptable.

At block 806, the processing system 600, using the detection engine 610, compares the floor flatness and levelness deviation to a threshold deviation. For each of the plurality of 3D coordinates, the floor flatness and levelness deviation can be a positive value, which indicates that the floor is above the reference plane at this point, or a negative value, which indicates that the floor is below the reference plane at this point. In some examples, the standard, design specification, or other guideline defines one or more thresholds (also referred to as “deviation thresholds”) such that values for points on the floor failing to satisfy a threshold may be deemed unacceptable. As an example, high and low thresholds can be defined, where points having a value above the high threshold or below the low threshold are deemed unacceptable. The graphical representation 1000 of FIG. 10 depicts such high and low thresholds as high threshold 1001 and low threshold 1002.

At block 808, the processing system 600, using the correction engine 612, responsive to determining that the floor flatness and levelness deviation fails to satisfy the threshold deviation, controls an automated system (e.g., the automated system 630) to correct a defect associated with the floor flatness and levelness deviation. In examples, the automated system 630 can be a system to automatically dispense a volume of material used to fill a low spot (defect) in the floor, to remove material on the floor to remove a high spot (defect), etc. For example, for a low spot, material can be added to fill the low spot. For a high spot for example, a machine such as a power float can be controlled to cause wet concrete at the high spot to be lowered. As another example for a high spot, a machine with a grinder (or other abrasion-based machine) can be used to remove the high spot.

According to one or more embodiments described herein, correcting the defect associated with the floor flatness and levelness deviation can include determining an amount of material to add based on the floor flatness and levelness deviation. Next, a volume of material is dispensed based at least in part on the determined amount of material. The volume of material is then applied to an area associated with the floor flatness and levelness deviation.

According to one or more embodiments described herein, correcting the defect associated with the floor flatness and levelness deviation can include determining an amount of material to remove based on the floor flatness and levelness deviation. Then, a volume of material is removed, based at least in part on the determined amount of material, from an area associated with the floor flatness and levelness deviation.

In one or more embodiments, the method 800 can be performed iteratively, as shown by the arrow 810, such than a new scan can be performed and the new scan data can be analyzed in accordance with blocks 802, 804, 806, 808.

Additional processes also may be included, and it should be understood that the process depicted in FIG. 8 represents an illustration, and that other processes may be added or existing processes may be removed, modified, or rearranged without departing from the scope of the present disclosure.

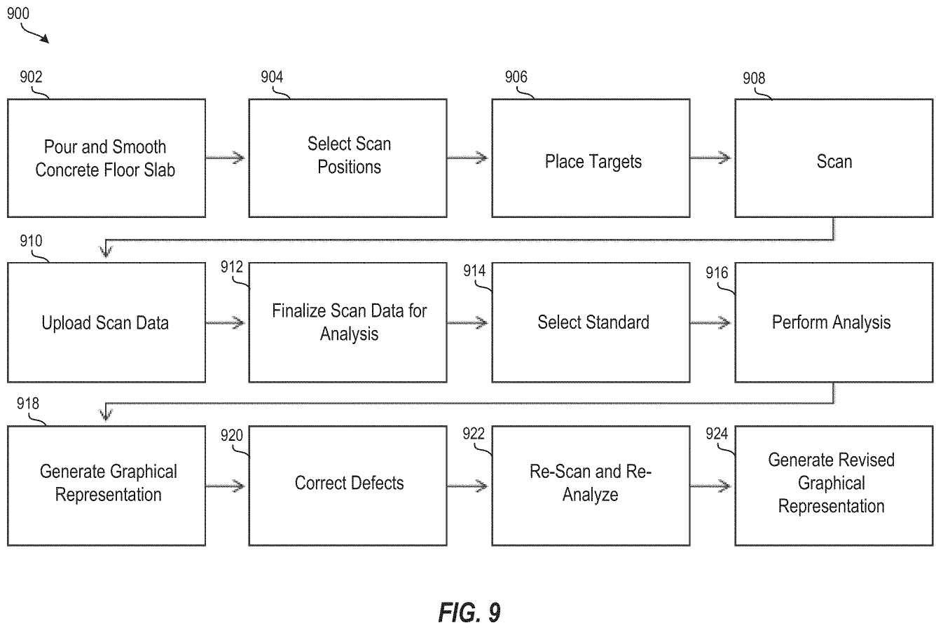

FIG. 9 depicts a flow diagram of a method 900 for determining floor flatness and levelness according to one or more embodiments described herein. The method 900 can be performed by any suitable system or device, such as the processing system 600 of FIG. 6 and/or the processing system 1800 of FIG. 18.

At block 902, concrete is poured and smoothed to create a concrete floor slab. At block 904, scan positions are determined and the laser scanners (e.g., the laser scanners 520) are positioned at the scan positions. At block 906, targets can be placed. Targets can be used to aid with aligning the data collected by the laser scanners. At block 908, a scan is performed using the laser scanners to collect data. At block 910, the scan data is uploaded from the laser scanners to a processing system (e.g., the processing system 600). In some examples, the processing system is on site where the scanning occurs or is at another location. The processing system, in some examples, can be one or more cloud computing nodes of a cloud computing environment.

At block 912, the processing system finalizes the scan data for analysis. This can include aligning the scan data, such as using the targets or other alignment techniques. At block 914, a standard is selected (e.g., ASTM E1155, CS TR34, DIN18202, etc.), and at block 916, the processing system 600 (using the determination engine 610) analyses the data to determine one or more flatness and levelness deviations. At block 918, the results of the analysis are visualized as graphical representations (see, e.g., the graphical representations 1000, 1100, and 1200 of FIGS. 10, 11, and 12 respectively). At block 920, defects can be corrected as described herein. At block 922, a new scan can be performed to collect new data, and the new data can be analyzed as described herein. At block 924, revised graphical representations, based on the new data, are generated.

Additional processes also may be included, and it should be understood that the process depicted in FIG. 9 represents an illustration, and that other processes may be added or existing processes may be removed, modified, or rearranged without departing from the scope of the present disclosure.

In some embodiments, floor flatness and levelness determination can be performed after one or more scans are completed. However, in other embodiments, it is possible to provide indications of flatness and/or levelness during a scan. In yet another embodiment, an initial flatness and/or levelness analysis can be performed during a scan (e.g., before a scan is complete) and an additional flatness and/or levelness analysis can be performed subsequent to the scan (or multiple scans) being complete. The initial analysis (e.g., during a scan) can be useful for providing real-time (or near-real time) results on levelness and/or flatness such that these conditions can be addressed right away. The additional flatness and/or levelness analysis can then be performed after the scan (or multiple scans) is complete. This provides for larger sets of data (such as from multiple scans and/or scan locations) to be included in the analysis.

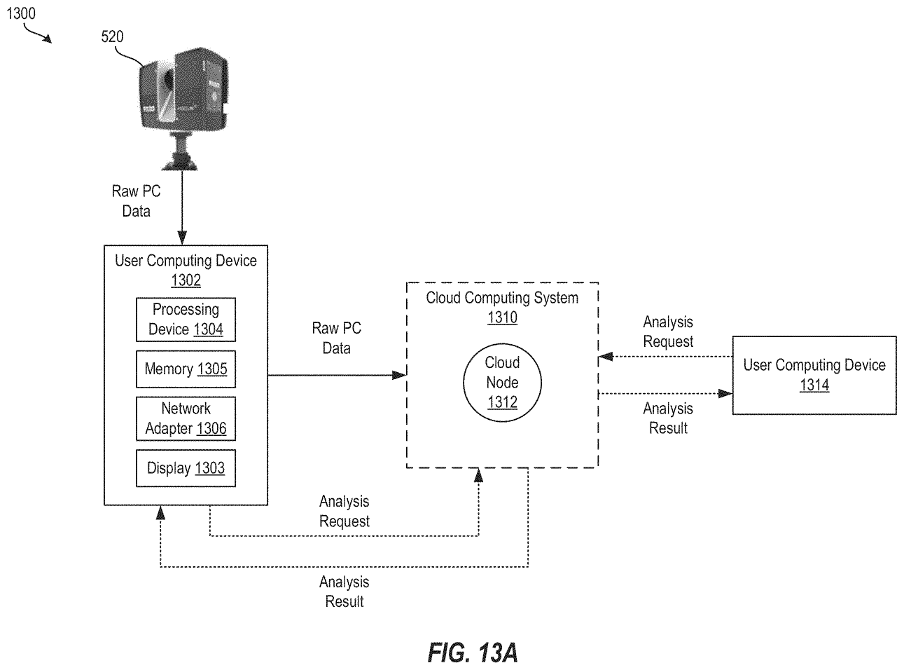

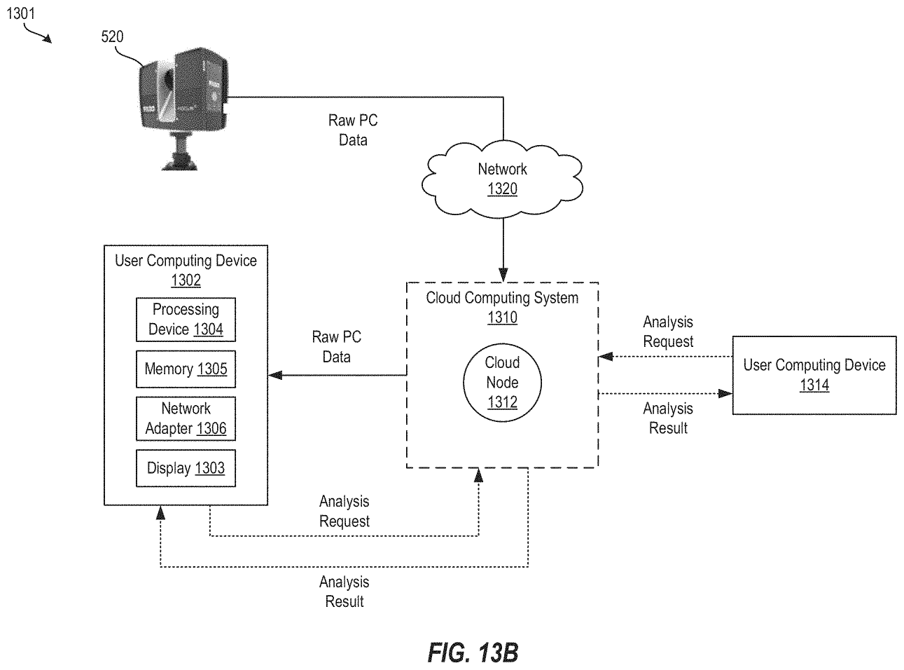

FIG. 13A is a block diagram of a system 1300 for performing object analysis, such as floor flatness analysis, object tracking, and/or the like including combinations and/or multiples thereof, according to one or more embodiments described herein. The system 1300 includes the laser scanner 520, a user computing device 1302, a cloud computing system 1310, and a user computing device 1314. The laser scanner 520 (or any other suitable 3D coordinate measurement device) captures data about an environment as described herein and transmits, via a wired and/or wireless communications link, the data to the user computing device 1302. The data can include raw data in the form of 3D coordinates or another suitable format.

The user computing device 1302 receives the raw data (e.g., raw point cloud (“PC”) data) and causes it to be displayed on a display 1303. According to one or more embodiments described herein, the user computing device 1302 is an example of the processing system 1800 of FIG. 18. According to one or more embodiments described herein, the user computing device 1302 is a mobile phone (e.g., a smartphone), a tablet computing device, a laptop computing device, and/or the like. The user computing device 1302 includes a processing device 1304 (e.g., one or more of the processing devices 1821 of FIG. 18), a system memory 1305 (e.g., the RAM 1824 and/or the ROM 1822 of FIG. 18), a network adapter 1306 (e.g., the network adapter 1826 of FIG. 18), and a display 1303.

The features and functionality of the user computing device 1302 can be implemented as instructions stored on a computer-readable storage medium, as hardware modules, as special-purpose hardware (e.g., application specific hardware, application specific integrated circuits (ASICs), application specific special processors (ASSPs), field programmable gate arrays (FPGAs), as embedded controllers, hardwired circuitry, etc.), or as some combination or combinations of these. According to aspects of the present disclosure, the engine(s) described herein can be a combination of hardware and programming The programming can be processor executable instructions stored on a tangible memory, and the hardware can include the processing device 1304 for executing those instructions. Thus the system memory 1305 can store program instructions that when executed by the processing device 1304 implement the engines described herein. Other engines can also be utilized to include other features and functionality described in other examples herein.

The user computing device 1302 receives from the laser scanner 520 the raw data and displays it in real-time (or near-real-time) on the display 1303. For example, the laser scanner 520 performs a scan by performing a plurality of rotations about an axis during the scan. According to one or more embodiments described herein, the laser scanner 520 rotates one every approximately 10 seconds (approximately 0.1 Hz), although other periods of rotation are also possible. During each of the plurality of rotations, the laser scanner 520 captures a plurality of 3D coordinates (e.g., raw data) of an environment. The 3D coordinates are transmitted directly from the laser scanner 520 to the user computing device 1302, such as by a wired and/or wireless connection (e.g., Bluetooth, WiFi, radio frequency, Ethernet, universal serial bus (USB), and/or the like, including combinations and/or multiples thereof). According to one or more embodiments described herein, the raw data are transmitted continuously, while in other embodiments, the raw data are transmitted in batches (e.g., one batch per rotation of the scanner 520).

The user computing device 1302 can also transmit the raw data to a cloud computing system 1310 and/or other suitable remote processing system/environment. For example, the user computing device 1302 can be connected by a wired and/or wireless connection (e.g., Bluetooth, WiFi, radio frequency, Ethernet, universal serial bus (USB), and/or the like, including combinations and/or multiples thereof) to the cloud computing system 1310. According to one or more embodiments, the user computing device 1302 is directly connected to the cloud computing system 1310, while in one or more other embodiments, the user computing device 1302 is indirectly connected to the cloud computing system 1310, such as by a network (e.g., the network 1320). The network represents any one or a combination of different types of suitable communications networks such as, for example, cable networks, public networks (e.g., the Internet), private networks, wireless networks, cellular networks, or any other suitable private and/or public networks. Further, the network can have any suitable communication range associated therewith and may include, for example, global networks (e.g., the Internet), metropolitan area networks (MANs), wide area networks (WANs), local area networks (LANs), or personal area networks (PANs). In addition, the network can include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof.

Cloud computing, by the cloud computing system 1310, can supplement, support, and/or replace some or all of the functionality of the elements of the system 1300. For example, some or all of the features and functionality described herein, such as performing a floor flatness analysis, a floor levelness analysis, object tracking, and/or the like including combinations and/or multiples thereof, can be implemented by a node 1312 (and/or multiple nodes (not shown)) of the cloud computing system 1310. An example of a cloud computing node is the processing system 1800 of FIG. 18, although according to one or more embodiments described herein, any suitable cloud computing node can be implemented and is not intended to suggest any limitation as to the scope of use or functionality of embodiments described herein. According to one or more embodiments described herein, the user computing device 1302 transmits the raw point cloud data to the cloud computing system 1310. The cloud computing system 1310 can then store and/or process the raw point cloud data. As an example, the cloud computing system 1310 can performing a floor flatness analysis, a floor levelness analysis, object tracking, and/or the like including combinations and/or multiples thereof. For example, the user computing device 1302 and/or another device such as the user computing device 1314 can transmit an analysis request to the cloud computing system 1310. The cloud computing system 1310 then performs the requested analysis (e.g., a floor flatness analysis, a floor levelness analysis, object tracking, and/or the like, including combinations and/or multiples thereof) and transmits an analysis result back to the requesting device as shown in FIG. 13A.

Thus, according to one or more embodiments described herein as shown in FIG. 13A, the user computing device 1302 can display raw data (e.g., raw point cloud data) from the laser scanner 520 on the display 1303 and can also transmit the raw data to a cloud computing system 1310 for further analysis.

FIG. 13B is a block diagram of a system 1301 for performing object analysis, such as floor flatness analysis, object tracking, and/or the like including combinations and/or multiples thereof, according to one or more embodiments described herein. Like the system 1300 of FIG. 13A, the system 1301 of FIG. 13B includes the laser scanner 520, the user computing device 1302, the cloud computing system 1310, and the user computing device 1314. In this embodiment, the laser scanner 520 scans an environment as described herein to collect raw data (e.g., the “raw PC data”). The laser scanner 520 transmits the raw data to the cloud computing system 1310 directly, such as via a network 1320.

The network 1320 represents any one or a combination of different types of suitable communications networks such as, for example, cable networks, public networks (e.g., the Internet), private networks, wireless networks, cellular networks, or any other suitable private and/or public networks. Further, the network 1320 can have any suitable communication range associated therewith and may include, for example, global networks (e.g., the Internet), metropolitan area networks (MANs), wide area networks (WANs), local area networks (LANs), or personal area networks (PANs). In addition, the network 1320 can include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof.

According to an embodiment, the laser scanner 520 transmits the raw data to the cloud computing system 1310 without sending the raw data to the user computing device 1302. According to an embodiment, the laser scanner 520 transmits the raw data to the cloud computing system 1310 independent of transmitting the raw data to the user computing device 1302.

Once the raw data are received, the cloud computing system 1310 can store the raw data in a memory, a storage device, and/or the like including combinations and/or multiples thereof. For example, the cloud computing system 1310 can store the raw data in mass storage 1834 of FIG. 1800.

According to one or more embodiments described herein, the cloud computing system 1310 can also transmit the raw data, in whole or in part, to the user computing device 1302. For example, the user computing device 1302 can be connected by a wired and/or wireless connection (e.g., Bluetooth, WiFi, radio frequency, Ethernet, universal serial bus (USB), and/or the like, including combinations and/or multiples thereof) to the cloud computing system 1310.

The user computing device 1302 can store the raw data, such as in the memory 1305 or a mass storage (not shown), such as the mass storage 1834 of FIG. 18. The user computing device 1302 can display the raw data, in real-time (or near-real-time) on the display 1303 as in FIG. 13A. For example, the laser scanner 520 performs a scan by performing a plurality of rotations about an axis during the scan. According to one or more embodiments described herein, the laser scanner 520 rotates one every approximately 10 seconds (approximately 0.1 Hz), although other periods of rotation are also possible. During each of the plurality of rotations, the laser scanner 520 captures a plurality of 3D coordinates (e.g., raw data) of an environment. The 3D coordinates are transmitted indirectly from the laser scanner 520 to the user computing device 1302 via the cloud computing system 1310, such as by a wired and/or wireless connection (e.g., Bluetooth, WiFi, radio frequency, Ethernet, universal serial bus (USB), and/or the like, including combinations and/or multiples thereof). According to one or more embodiments described herein, the raw data are transmitted continuously, while in other embodiments, the raw data are transmitted in batches (e.g., one batch per rotation of the scanner 520).

Like in the system 1300, the user computing device 1302 and/or the user computing device 1314 can transmit analysis requests to the cloud computing system 1310. The cloud computing system 1310 then performs the requested analysis (e.g., a floor flatness analysis, a floor levelness analysis, object tracking, and/or the like, including combinations and/or multiples thereof) and transmits an analysis result back to the requesting device as shown in FIG. 13B.

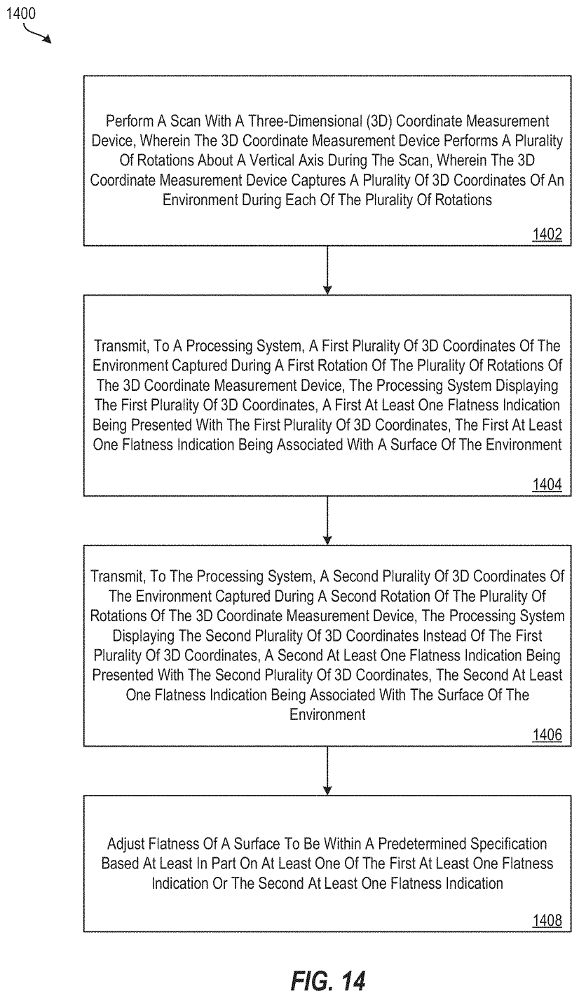

FIG. 14 is a method for performing a surface flatness analysis according to one or more embodiments described herein. The method 1400 can be performed by any suitable system or device, such as the processing system 600 of FIG. 6, the user computing device 1302, and/or the processing system 1800 of FIG. 18.

At block 1402, a three-dimensional (3D) coordinate measurement device (e.g., the laser scanner 520) performs a scan. Particularly, the 3D coordinate measurement device (e.g., the laser scanner 520) performs a plurality of rotations about an axis during the scan. In an example where the 3D coordinate measurement device is scanning an environment having a surface of interest (e.g., a floor or wall to be analyzed according to the embodiments described herein), the axis can be substantially perpendicular to that surface of interest. For example, for a floor flatness analysis for a floor along a horizontal plane, the axis of the 3D coordinate measurement device is substantially vertical. The 3D coordinate measurement device (e.g., the laser scanner 520) captures a plurality of 3D coordinates of an environment (e.g., the floor 500) during each of the plurality of rotations.

At block 1404, the 3D coordinate measurement device (e.g., the laser scanner 520) transmits, to a processing system (e.g., the user computing device 1302), a first plurality of 3D coordinates of the environment captured during a first rotation of the plurality of rotations of the 3D coordinate measurement device. The processing system (e.g., the user computing device 1302) displays the first plurality of 3D coordinates (e.g., on the display 1303). The processing system (e.g., the user computing device 1302) also displays a first at least one flatness indication with the first plurality of 3D coordinates (see, e.g., FIGS. 10, 11, 12).

At block 1406, the 3D coordinate measurement device (e.g., the laser scanner 520) transmits, to the processing system (e.g., the user computing device 1302), a second plurality of 3D coordinates of the environment captured during a second rotation of the plurality of rotations of the 3D coordinate measurement device. The processing system (e.g., the user computing device 1302) displays the second plurality of 3D coordinates (e.g., on the display 1303) instead of the first plurality of 3D coordinates. The processing system (e.g., the user computing device 1302) also displays a second at least one flatness indication with the second plurality of 3D coordinates (see, e.g., FIGS. 10, 11, 12). According to one or more embodiments described herein, the at least one of the first at least one flatness indication or the second at least one flatness indication is based at least in part on a reference point located on or adjacent to the surface of the environment that is being scanned and analyzed. For example, the reference point is used to define a reference plane, and the at least one of the first at least one flatness indication or the second at least one flatness indication is based at least in part on the reference plane. According to one or more embodiments described herein, the at least one of the first at least one flatness indication or the second at least one flatness indication is displayed as an augmented reality element, as a function of distance relative to the reference plane, as a heatmap, and/or the like, including combinations and/or multiples thereof.

According to one or more embodiments described herein, the reference plane can be identified by the user computing device 1302. For example, the user computing device 1302 can look for a collection of points with similarity of one dimension of three-dimensional space (e.g., a collection of points having similar z-axis coordinates (e.g., a value within a certain threshold of other values)). The flatness evaluation can be performed by comparing to the reference plane, such as by comparing to an average value of the points of the identified plane, by comparing to a minimum or maximum value of the points of the identified plane, etc. In such cases, the first at least one flatness indication and/or the second at least one flatness indication is presented as a value (+/−) relative to the average/minimum/maximum.

According to one or more embodiments described herein, the reference plane can be determined using a digital model, such as a computer aided design (CAD) model, a building information modeling (BIM) model, and/or the like, including combinations and/or multiples thereof. In such cases, the raw data is compared to the digital model, and registration is performed between the raw data and the model to align the raw data and the model. Once registered and aligned, movement of the user computing device 1302 can be tracked, such as using simultaneous localization and mapping (SLAM) techniques.

According to one or more embodiments described herein, the reference plane is defined by a user. For example, a user of the user computing device 1302 can select a plane on the display 1303 or using another suitable input.

At block 1408, a surface can be adjusted to be within a predetermined specification based at least in part on at least one of the first at least one flatness indication or the second at least one flatness indication. For example, adjusting the flatness of the surface can include determining an amount of material to add to the surface based at least in part on the at least one of the first at least one flatness indication or the second at least one flatness indication and then dispensing a volume of material based at least in part on the determined amount of material. As another example, adjusting the flatness of the surface can include determining an amount of material to redistribute on the surface based at least in part on the at least one of the first at least one flatness indication or the second at least one flatness indication and then redistributing a volume of material based at least in part on the determined amount of material. Redistributing can include, for example, spreading or otherwise relocating the material from one area to another area, such as using a power float or other tool, device, system, and/or the like, including combination and/or multiples thereof. As yet another example, adjusting the flatness of the surface can include determining an amount of material to remove on the surface based at least in part on the at least one of the first at least one flatness indication or the second at least one flatness indication and then removing a volume of material based at least in part on the determined amount of material. Removing can include, for example, using a grinder or other abrasion-based machine to remove a high spot.

Additional processes also may be included. For example, the method 1400 can include transmitting the first plurality of 3D coordinates of the environment and the second plurality of 3D coordinates of the environment to a cloud computing environment. In such cases, a cloud node of the cloud computing environment performs an analysis task (e.g., a floor flatness analysis, a floor levelness analysis, and/or the like, including combinations and/or multiples thereof) responsive to an analysis request and provides analysis results, such as to the requesting device or another device. It should be understood that the process depicted in FIG. 14 represents an illustration, and that other processes may be added or existing processes may be removed, modified, or rearranged without departing from the scope of the present disclosure.

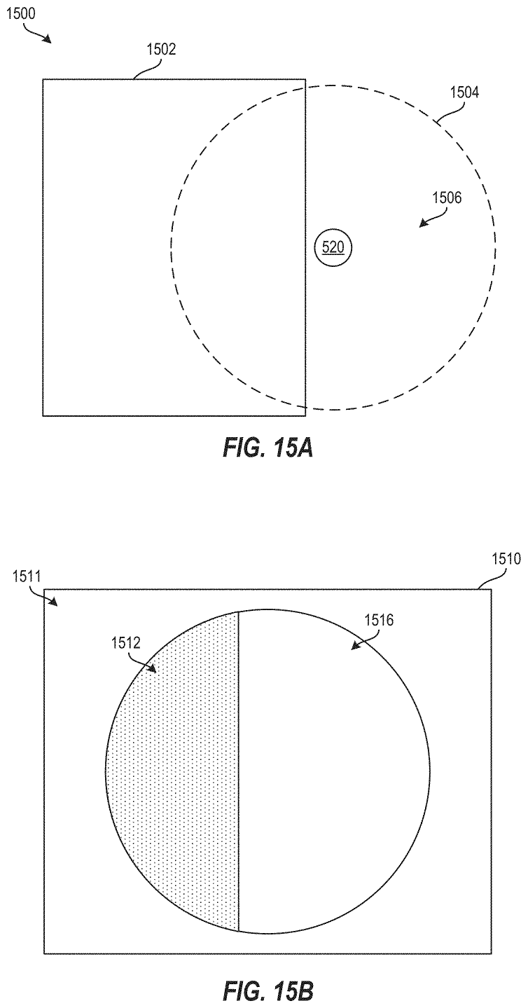

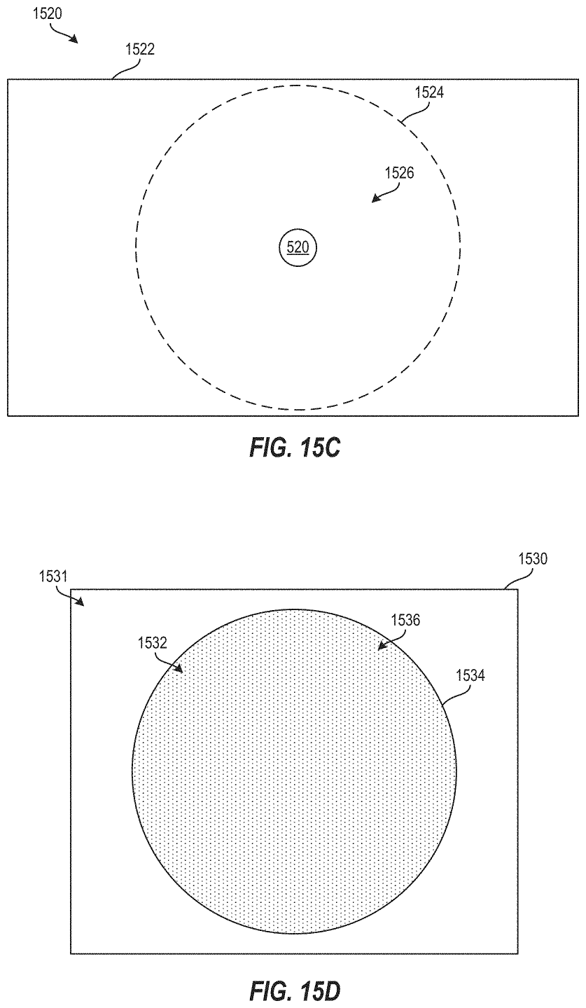

FIG. 15A is a diagram of environment 1500 to be scanned by a 3D coordinate measurement device (e.g., the laser scanner 520) according to one or more embodiments described herein. In this example, the environment 1500 includes a surface 1502, such as a wall or floor, to be analyzed for flatness. The scanner 520 is positioned proximate to the surface 1502, and the scanner begins capturing 3D coordinate data for the environment 1500. The laser scanner 520 performs a plurality of rotations about an axis during the scan. In this example, the axis is orthogonal to a plane defined by the surface 1502. During each rotation, the laser scanner 520 captures data within a scan area 1506 defined by a boundary 1504. The boundary 1504 is determined based on the properties and/or capabilities of the laser scanner 520. In some cases, the boundary 1504 can be set/programmed, while in other examples the boundary 1504 is based on a distance the laser scanner 520 can capture.

FIG. 15B is a diagram of an interface 1511 on a display 1510 (e.g., the display 1303) for displaying results of a surface flatness analysis of the surface 1502 of the environment 1500 of FIG. 15A according to one or more embodiments described herein. In this example, the interface 1511 shows data 1512, 1516 associated with the scan area 1506. The data 1512 represents the data associated with the surface 1502 while the data 1516 represents data within the scan area 1506 that is not associated with the surface 1502. According to one or more embodiments described herein, the data 1516 can be disregarded since it is not associated with the surface 1502. As described herein, the data 1512 can be updated in real-time (or near-real-time) on a device (e.g., the user computing device 1302) while the laser scanner 520 captures the data 1512.

FIG. 15C is a diagram of environment 1520 to be scanned by a 3D coordinate measurement device (e.g., the laser scanner 520) according to one or more embodiments described herein. In this example, the environment 1520 includes a surface 1522, such as a wall or floor, to be analyzed for flatness. The scanner 520 is positioned on or above the surface 1522, and the scanner begins capturing 3D coordinate data for the environment 1500 as described herein within a boundary 1524.

FIG. 15D is a diagram of an interface 1531 on a display 1530 (e.g., the display 1303) for displaying results of a surface flatness analysis of the surface 1522 of the environment of FIG. 15C according to one or more embodiments described herein. In this example, the interface 1531 shows data 1532 associated with the scanned area 1526. The data 1532 represents the data associated with the surface 1522. As described herein, the data 1532 can be updated in real-time (or near-real-time) on a device (e.g., the user computing device 1302) while the laser scanner 520 captures the data 1532.

One or more embodiments described herein provide for object tracking. As an example, a digital form of an object may be determined or previously known, such as from reference data or a model. A laser scanner can be used to scan the object to track the object relative to the reference data or model. An example of an object is an object that moves (e.g., a person, a piece of equipment, a machine, a piece of furniture, a robot, and/or the like, including combinations and/or multiples thereof) within an environment (e.g., a factory, warehouse, construction site, airport, store, and/or the like, including combinations and/or multiples thereof). A laser scanner as described herein can be used to scan the factory to track the object. As another example, an object could be a surface (e.g., a curved surface, a planar surface, and/or the like, including combinations and/or multiples thereof), such as a floor, wall, ceiling, etc. of a building under construction or renovation. A laser scanner as described herein can be used to scan the building to track the object, such as construction developments related to the object (e.g., has the concrete floor been poured, has the wall been constructed, etc.). Other examples of the objects to be tracked are possible and could take different forms and/or different complexities. For example, an object could take the form of a geometric primitive, a free-form surface, and/or the like, including combinations and/or multiples thereof.

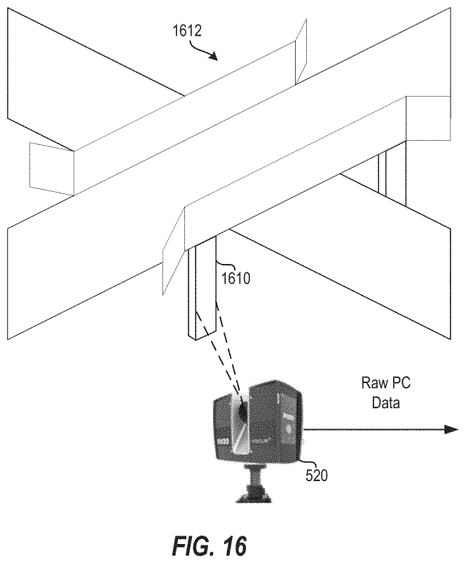

One example use case for object tracking is shown in and described with respect to FIG. 16. In the example of FIG. 16, a pillar 1610 of a bridge 1612 is an object to be tracked. According to one or more embodiments described herein, the laser scanner 520 scans the pillar 1610 of the bridge 1612. As an example, the scanner 510 scans the pillar 1610 periodically, such as every 1/100 of a second, and collects raw data (e.g., raw point cloud data). As described with reference to FIGS. 13A, 13B, the raw data can be transmitted to the user computing device 1302 and/or the cloud computing system 1310. The raw data can then be analyzed by the user computing device 1302 and/or the cloud computing system 1310 and/or presented for display to a user, such as on the display 1303 of the user computing device 1302 (e.g., in real-time (or near-real-time)).

The raw data can be analyzed to reference data. Examples of reference data can include prior (historic) data collected by a laser scanner, a computer aided design (CAD) model, a building information modeling (BIM) model, and/or the like, including combinations and/or multiples thereof. For example, a point from the point cloud of the raw data can be compared to a corresponding point in the reference data. According to one or more embodiments described herein, the corresponding points can be compared by determining a distance between the point cloud of the raw data and the corresponding point in the reference data. Examples of distance measurement techniques for measuring the distance between the corresponding points include Euclidean distance, Hamming distance, Manhattan distance, and/or the like, including combinations and/or multiples thereof.

According to one or more embodiments described herein, the user computing device 1302 can perform a real-time (or near-real-time) analysis to compare the raw data to the reference data and display information about the analysis on the display 1303. According to the example of FIG. 16, the laser scanner 520 scans the pillar 1610 of the bridge 1612. Data can be collected at particular times and/or upon the occurrence of a particular event. One such example of an event is a train (not shown) crossing the bridge 1612. When the train crosses the bridge 1612, the laser scanner 520 collects the raw data about the pillar 1610 and transmits the raw data to the user computing device 1302 and/or to the cloud computing system 1310. The user computing device 1302 and/or the cloud computing system 1310 can compare the raw data for the pillar 1610 collected when the train crosses the bridge 1612 with reference data, such as construction data about the pillar 1610 (e.g., a model), historic data collected at a prior time (e.g., during a previous train crossing, during a time when no train is crossing), and/or the like, including combinations and/or multiples thereof. As an example, the raw data for the pillar 1610 collected when the train crosses the bridge 1612 is compared to data collected by the laser scanner 520 when no train is crossing (e.g., one or more points from the raw data is compared to corresponding one or more points of the data collected when not train is crossing using one or more distance measurement techniques as described herein). This provides for evaluating how the pillar 1610 responds to the load and forces generated by the train crossing the bridge 1612. As another example, the raw data for the pillar 1610 collected when the train crosses the bridge 1612 is compared to historic data collected by the laser scanner 520 when train previously crossed the bridge 1612 (e.g., one or more points from the raw data is compared to corresponding one or more points of the data collected when a train previously crossed the bridge 1612 using one or more distance measurement techniques as described herein). This provides for evaluating how the pillar 1610 responds to the load and forces generated by the train crossing the bridge 1612 over time.

It should be appreciated that the embodiment of FIG. 16 is merely an example, and other use cases are also possible. For example, the scanner 520 can be used to scan an environment, such as a factory or warehouse, to determine movement of people, objects, etc., within the environment. This can be useful, for example, to detect whether an object or person is within a restricted area, to detect changes to where objects are located within the environment over time, and/or the like, including combinations and/or multiples thereof.

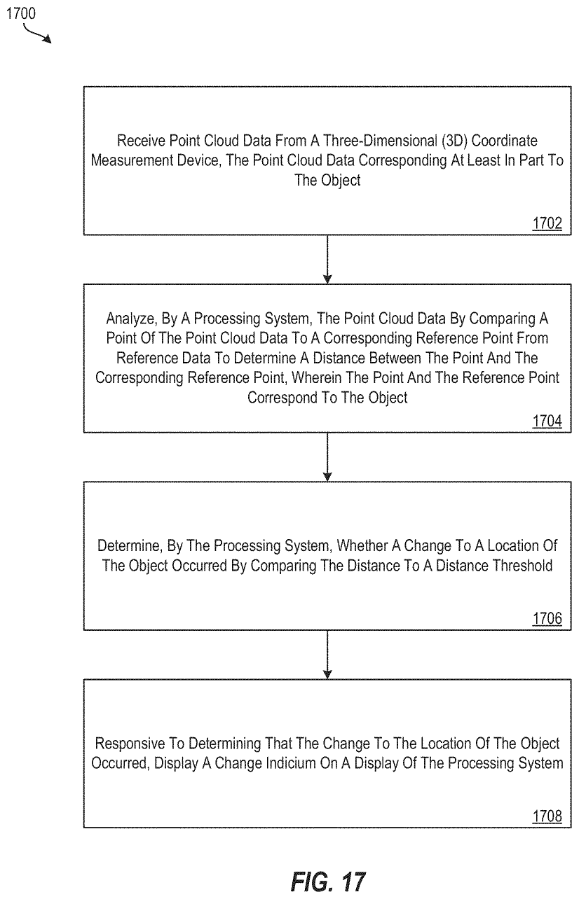

FIG. 17 is a flow diagram of a method 1700 for object tracking according to one or more embodiments described herein. The method 1700 can be performed by any suitable system or device, such as the processing system 600 of FIG. 6, the user computing device 1302 of FIGS. 13A, 13B, the cloud computing system 1310 of FIGS. 13A, 13B, and/or the processing system 1800 of FIG. 18.

At block 1702, a processing system (e.g., the user computing device 1302) receives point cloud data (e.g., raw point cloud data) from a three-dimensional (3D) coordinate measurement device (e.g., the laser scanner 520). The point cloud data corresponds at least in part to the object (e.g., a surface, a geometric primitive, a free-form shape, and/or the like, including combinations and/or multiples thereof).

At block 1704, the processing system analyzes the point cloud data by comparing a point of the point cloud data to a corresponding reference point from reference data to determine a distance between the point and the corresponding reference point. The point and the reference point correspond to the object. The reference data can be historic point cloud data, data from a model (e.g., a CAD model, a BIM model), and/or the like, including combinations and/or multiples thereof.

At block 1706, the processing system determines whether a change to a location of the object occurred by comparing the distance to a distance threshold. For example, a distance threshold can be set by a user, can be set automatically, and/or the like, including combinations and/or multiples thereof. If the distance is greater than (or greater than or equal to) the distance threshold, a change can be determined to have occurred.

At block 1708, responsive to determining that the change to the location of the object occurred, the processing system displays, on a display (e.g., the display 1303) a change indicium. The change indicium could be a label indicating the distance, a change of color of a point corresponding to the distance that is greater than the distance threshold, a label, and/or the like, including combinations and/or multiples thereof, including any suitable audible and/or visual indicum.

According to one or more embodiments described herein, the point cloud data is captured by performing a scan using the 3D coordinate measurement device. According to one or more embodiments described herein, the 3D coordinate measurement device performs a plurality of rotations about an axis during the scan. According to one or more embodiments described herein, the 3D coordinate measurement device captures a plurality of 3D coordinates of the object during each of the plurality of rotations. According to one or more embodiments described herein, the 3D coordinate measurement device transmits, to the processing system, a first plurality of 3D coordinates of the object captured during a first rotation of the plurality of rotations of the 3D coordinate measurement device. The processing system displays the first plurality of 3D coordinates on the display. According to one or more embodiments described herein, the 3D coordinate measurement device transmits, to the processing system, a second plurality of 3D coordinates of the object captured during a second rotation of the plurality of rotations of the 3D coordinate measurement device. The processing system displays, on the display, the second plurality of 3D coordinates instead of the first plurality of 3D coordinates.

It is understood that one or more embodiments described herein is capable of being implemented in conjunction with any other type of computing environment now known or later developed. For example, FIG. 18 depicts a block diagram of a processing system 1800 for implementing the techniques described herein. In accordance with one or more embodiments described herein, the processing system 181800 is an example of a cloud computing node of a cloud computing environment. In examples, processing system 1800 has one or more central processing units (“processors” or “processing resources” or “processing devices”) 1821a, 1821b, 1821c, etc. (collectively or generically referred to as processor(s) 1821 and/or as processing device(s)). In aspects of the present disclosure, each processor 1821 can include a reduced instruction set computer (RISC) microprocessor. Processors 1821 are coupled to system memory (e.g., random access memory (RAM) 1824) and various other components via a system bus 1833. Read only memory (ROM) 1822 is coupled to system bus 1833 and may include a basic input/output system (BIOS), which controls certain basic functions of processing system 1800.

Further depicted are an input/output (I/O) adapter 1827 and a network adapter 1826 coupled to system bus 1833. 110 adapter 1827 may be a small computer system interface (SCSI) adapter that communicates with a hard disk 1823 and/or a storage device 1825 or any other similar component. 110 adapter 1827, hard disk 1823, and storage device 1825 are collectively referred to herein as mass storage 1834. Operating system 1840 for execution on processing system 1800 may be stored in mass storage 1834. The network adapter 1826 interconnects system bus 1833 with an outside network 1836 enabling processing system 1800 to communicate with other such systems.

A display (e.g., a display monitor) 1835 is connected to system bus 1833 by display adapter 1832, which may include a graphics adapter to improve the performance of graphics intensive applications and a video controller. In one aspect of the present disclosure, adapters 1826, 1827, and/or 1832 may be connected to one or more 110 busses that are connected to system bus 1833 via an intermediate bus bridge (not shown). Suitable 110 buses for connecting peripheral devices such as hard disk controllers, network adapters, and graphics adapters typically include common protocols, such as the Peripheral Component Interconnect (PCI). Additional input/output devices are shown as connected to system bus 1833 via user interface adapter 1828 and display adapter 1832. A keyboard 1829, mouse 1830, and speaker 1831 may be interconnected to system bus 1833 via user interface adapter 1828, which may include, for example, a Super 110 chip integrating multiple device adapters into a single integrated circuit.

In some aspects of the present disclosure, processing system 1800 includes a graphics processing unit 1837. Graphics processing unit 1837 is a specialized electronic circuit designed to manipulate and alter memory to accelerate the creation of images in a frame buffer intended for output to a display. In general, graphics processing unit 1837 is very efficient at manipulating computer graphics and image processing, and has a highly parallel structure that makes it more effective than general-purpose CPUs for algorithms where processing of large blocks of data is done in parallel.

Thus, as configured herein, processing system 1800 includes processing capability in the form of processors 1821, storage capability including system memory (e.g., RAM 1824), and mass storage 1834, input means such as keyboard 1829 and mouse 1830, and output capability including speaker 1831 and display 1835. In some aspects of the present disclosure, a portion of system memory (e.g., RAM 1824) and mass storage 1834 collectively store the operating system 1840 to coordinate the functions of the various components shown in processing system 1800.

It will be appreciated that one or more embodiments described herein may be embodied as a system, method, or computer program product and may take the form of a hardware embodiment, a software embodiment (including firmware, resident software, micro-code, etc.), or a combination thereof. Furthermore, one or more embodiments described herein may take the form of a computer program product embodied in one or more computer readable medium(s) having computer readable program code embodied thereon.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A method for tracking an object comprising:
receiving point cloud data from a three-dimensional (3D) coordinate measurement device, the point cloud data corresponding at least in part to the object;
analyzing, by a processing system, the point cloud data by comparing a point of the point cloud data to a corresponding reference point from reference data to determine a distance between the point and the corresponding reference point, wherein the point and the corresponding reference point are associated with the object;
determining, by the processing system, whether a change to a location of the object occurred by comparing the distance to a distance threshold; and
responsive to determining that the change to the location of the object occurred, displaying a change indicium on a display of the processing system,
wherein the point cloud data is captured by performing a scan using the 3D coordinate measurement device,
wherein the 3D coordinate measurement device:
performs a plurality of rotations about an axis during the scan,
captures a plurality of 3D coordinates of the object during each of the plurality of rotations,
transmits, to the processing system, a first plurality of 3D coordinates of the object captured during a first rotation of the plurality of rotations of the 3D coordinate measurement device, the processing system displaying the first plurality of 3D coordinates on the display, and
transmits, to the processing system, a second plurality of 3D coordinates of the object captured during a second rotation of the plurality of rotations of the 3D coordinate measurement device, the processing system displaying, on the display, the second plurality of 3D coordinates instead of the first plurality of 3D coordinates.

2. The method of claim 1, wherein the 3D coordinate measurement device transmits the first plurality of 3D coordinates and the second plurality of 3D coordinates to a cloud computing system via network.

3. The method of claim 1, wherein the processing system transmits the first plurality of 3D coordinates and the second plurality of 3D coordinates to a cloud computing system.

4. The method of claim 1, wherein the object is a geometric primitive.

5. The method of claim 1, wherein the object is a planar surface.

6. The method of claim 1, wherein the object is a curved surface.

7. The method of claim 1, wherein the object is a free-form surface.

8. The method of claim 1, wherein the distance is selected from the group consisting of a Euclidean distance, a Hamming distance, and a Manhattan distance.

9. The method of claim 1, wherein the 3D coordinate measurement device is a laser scanner.

10. The method of claim 9, wherein the laser scanner comprises:
a scanner processing system including a scanner controller;
a housing; and
a 3D scanner disposed within the housing and operably coupled to the scanner processing system, the 3D scanner having a light source, a beam steering unit, a first angle measuring device, a second angle measuring device, and a light receiver, the beam steering unit cooperating with the light source and the light receiver to define a scan area, the light source and the light receiver configured to cooperate with the scanner processing system to determine a first distance to a first object point based at least in part on a transmitting of a light by the light source and a receiving of a reflected light by the light receiver, the 3D scanner configured to cooperate with the scanner processing system to determine 3D coordinates of the first object point based at least in part on the first distance, a first angle of rotation, and a second angle of rotation.

11. A system for tracking an object, the system comprising:
a three-dimensional (3D) coordinate measurement device; and
a processing system comprising a display,
wherein the 3D coordinate measurement device captures point cloud data by:
performing a scan by performing a plurality of rotations about an axis during the scan,
capturing a plurality of 3D coordinates of the object during each of the plurality of rotations,
transmitting, to the processing system, a first plurality of 3D coordinates of the object captured during a first rotation of the plurality of rotations of the 3D coordinate measurement device, the processing system displaying the first plurality of 3D coordinates on the display, and
transmitting, to the processing system, a second plurality of 3D coordinates of the object captured during a second rotation of the plurality of rotations of the 3D coordinate measurement device, the processing system displaying, on the display, the second plurality of 3D coordinates instead of the first plurality of 3D coordinates; and
wherein the processing system analyzes the point cloud data by:
analyzing the point cloud data by comparing a point of the point cloud data to a corresponding reference point from reference data to determine a distance between the point and the corresponding reference point, wherein the point and the corresponding reference point are associated with the object,
determining whether a change to a location of the object occurred by comparing the distance to a distance threshold, and
responsive to determining that the change to the location of the object occurred, displaying a change indicium on the display.

12. The system of claim 11, wherein the 3D coordinate measurement device transmits the first plurality of 3D coordinates and the second plurality of 3D coordinates to a cloud computing system via network.

13. The system of claim 11, wherein the processing system transmits the first plurality of 3D coordinates and the second plurality of 3D coordinates to a cloud computing system.

14. The system of claim 11, wherein the object is a geometric primitive.

15. The system of claim 11, wherein the object is a planar surface.

16. The system of claim 11, wherein the object is a curved surface.

17. The system of claim 11, wherein the object is a free-form surface.

18. The system of claim 11, wherein the distance is selected from the group consisting of a Euclidean distance, a Hamming distance, and a Manhattan distance.

19. The system of claim 11, wherein the 3D coordinate measurement device is a laser scanner.

20. The system of claim 19, wherein the laser scanner comprises:
a scanner processing system including a scanner controller;
a housing; and
a 3D scanner disposed within the housing and operably coupled to the scanner processing system, the 3D scanner having a light source, a beam steering unit, a first angle measuring device, a second angle measuring device, and a light receiver, the beam steering unit cooperating with the light source and the light receiver to define a scan area, the light source and the light receiver configured to cooperate with the scanner processing system to determine a first distance to a first object point based at least in part on a transmitting of a light by the light source and a receiving of a reflected light by the light receiver, the 3D scanner configured to cooperate with the scanner processing system to determine 3D coordinates of the first object point based at least in part on the first distance, a first angle of rotation, and a second angle of rotation.
